(19) United States
(12) Patent Application Publication
(10) Pub. No.: US 2026/0039368 A1
(43) Pub. Date: Feb. 5, 2026

(54) QUASI-CO-LOCATION TYPE-D ASSUMPTION DETERMINATION FOR CROSS-LINK INTERFERENCE MEASUREMENT

(71) Applicant: QUALCOMM Incorporated, San Diego, CA (US)

(72) Inventors: Qian ZHANG, Basking Ridge, NJ (US); Yan ZHOU, San Diego, CA (US); Muhammad Sayed Khairy ABDELGHAFFAR, San Jose, CA (US); Abdelrahman Mohamed Ahmed Mohamed IBRAHIM, San Diego, CA (US)

(21) Appl. No.: 18/791,314

(22) Filed: Jul. 31, 2024

(51) Int. Cl. H04B 7/06; H04B 17/318

(52) U.S. Cl. CPC H04B 7/06968; H04B 17/328

(57) ABSTRACT

Various aspects of the present disclosure generally relate to wireless communication. In some aspects, a user equipment (UE) may receive a cross-link interference (CLI) resource configuration for a UE-to-UE CLI measurement resource. The UE may determine a quasi-co-location (QCL) Type-D assumption per CLI resource based at least in part on a rule or a configuration associated with QCL Type-D assumption determination. The UE may measure UE-to-UE CLI based at least in part on the determined QCL Type-D assumption per CLI resource and the CLI measurement resource. The UE may transmit a CLI report that indicates CLI measurement results associated with the determined QCL Type-D assumption. Numerous other aspects are described.

### FIELD OF THE DISCLOSURE

Aspects of the present disclosure generally relate to wireless communication and specifically relate to techniques, apparatuses, and methods for determining a quasi-co-location Type-D assumption.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a user equipment (UE). The method may include receiving a cross-link interference (CLI) resource configuration for a UE-to-UE CLI measurement resource. The method may include determining a quasi-co-location (QCL) Type-D assumption per CLI resource based at least in part on a rule or a configuration associated with QCL Type-D assumption determination. The method may include measuring UE-to-UE CLI based at least in part on the determined QCL Type-D assumption per CLI resource and the CLI measurement resource. The method may include transmitting a CLI report that indicates CLI measurement results associated with the determined QCL Type-D assumption.

Some aspects described herein relate to a method of wireless communication performed by a network entity. The method may include transmitting a rule or a configuration associated with QCL Type-D assumption determination. The method may include receiving a CLI report that indicates CLI measurements and a determined QCL Type-D assumption.

Some aspects described herein relate to an apparatus for wireless communication at a UE. The apparatus may include one or more memories and one or more processors coupled to the one or more memories. The one or more processors may be configured to receive a CLI resource configuration for a UE-to-UE CLI measurement resource. The one or more processors may be configured to determine a QCL Type-D assumption per CLI resource based at least in part on a rule or a configuration associated with QCL Type-D assumption determination. The one or more processors may be configured to measure UE-to-UE CLI based at least in part on the determined QCL Type-D assumption per CLI resource and the CLI measurement resource. The one or more processors may be configured to transmit a CLI report that indicates CLI measurement results associated with the determined QCL Type-D assumption.

Some aspects described herein relate to an apparatus for wireless communication at a network entity. The apparatus may include one or more memories and one or more processors coupled to the one or more memories. The one or more processors may be configured to transmit a rule or a configuration associated with QCL Type-D assumption determination. The one or more processors may be configured to receive a CLI report that indicates CLI measurements and a determined QCL Type-D assumption.

Some aspects described herein relate to a non-transitory computer-readable medium that stores a set of instructions for wireless communication by a UE. The set of instructions, when executed by one or more processors of the UE, may cause the UE to receive a CLI resource configuration for a UE-to-UE CLI measurement resource. The set of instructions, when executed by one or more processors of the UE, may cause the UE to determine a QCL Type-D assumption per CLI resource based at least in part on a rule or a configuration associated with QCL Type-D assumption determination. The set of instructions, when executed by one or more processors of the UE, may cause the UE to measure UE-to-UE CLI based at least in part on the determined QCL Type-D assumption per CLI resource and the CLI measurement resource. The set of instructions, when executed by one or more processors of the UE, may cause the UE to transmit a CLI report that indicates CLI measurement results associated with the determined QCL Type-D assumption.

Some aspects described herein relate to a non-transitory computer-readable medium that stores a set of instructions for wireless communication by a network entity. The set of instructions, when executed by one or more processors of the network entity, may cause the network entity to transmit a rule or a configuration associated with QCL Type-D assumption determination. The set of instructions, when executed by one or more processors of the network entity, may cause the network entity to receive a CLI report that indicates CLI measurements and a determined QCL Type-D assumption. Some aspects described herein relate to an apparatus for wireless

communication. The apparatus may include means for receiving a CLI resource configuration for a UE-to-UE CLI measurement resource. The apparatus may include means for determining a QCL Type-D assumption per CLI resource based at least in part on a rule or a configuration associated with QCL Type-D assumption determination. The apparatus may include means for measuring UE-to-UE CLI based at least in part on the determined QCL Type-D assumption per CLI resource and the CLI measurement resource. The apparatus may include means for transmitting a CLI report that indicates CLI measurement results associated with the determined QCL Type-D assumption.

Some aspects described herein relate to an apparatus for wireless communication. The apparatus may include means for transmitting a rule or a configuration associated with QCL Type-D assumption determination. The apparatus may include means for receiving a CLI report that indicates CLI measurements and a determined QCL Type-D assumption.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIG. 4 is a diagram illustrating examples of full-duplex (FD) communication in a wireless network, in accordance with the present disclosure.

FIG. 5 is a diagram illustrating an example of cross-link interference (CLI), in accordance with the present disclosure.

FIG. 6 is a diagram illustrating an example associated with determining a quasi-co-location (QCL) Type-D assumption for CLI measurement, in accordance with the present disclosure.

FIG. 7 is a diagram illustrating an example of semi-persistent CLI resources, in accordance with the present disclosure.

FIG. 8 is a diagram illustrating an example process performed, for example, at a UE or an apparatus of a UE, in accordance with the present disclosure.

FIG. 9 is a diagram illustrating an example process performed, for example, at a network entity or an apparatus of a network entity, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Subband full-duplex (SBFD) may increase an uplink duty cycle, improve uplink coverage, and reduce latency, because it is possible to transmit an uplink signal in an uplink subband in downlink only or in flexible slots. SBFD may enhance system capacity, resource utilization, and spectrum efficiency. SBFD may enable flexible and dynamic uplink and downlink resource adaption according to uplink and downlink traffic in a robust manner. When SBFD is used, there may be cross-link interference (CLI) when messages are transmitted on nearby links at the same time. There are different types of CLI. For SBFD communications, CLI may include inter-subband (inter-SB) CLI between subbands, intra-cell CLI with a cell, inter-cell CLI between cells (e.g., Cell 1 and Cell 2), or inter-UE CLI between UEs. CLI may also include inter-gNB CLI between network entities (e.g., gNBs). For partially or fully overlapped full duplex (FD), there may be intra-cell CLI within a cell or inter-cell CLI between cells (e.g., Cell 1 and Cell 2).

A user equipment (UE) may use a CLI measurement resource for measuring CLI. The CLI measurement resource may be a sounding reference signal (SRS) reference signal received power (RSRP) for RSRP measurements of CLI, or a CLI-received signal strength indicator (RSSI) for RSSI measurements of CLI. A CLI framework may support both RSRP and RSSI measurements using a CLI resource configuration. The UE may take CLI measurements with the CLI measurement resource on a latest receive beam and generate a CLI report that uses the CLI measurements. The UE may transmit the CLI report (e.g., in a channel state information (CSI) report) to the network entity. The CLI report may be periodic or event-based.

A network entity (e.g., gNB) may transmit a physical downlink shared channel (PDSCH) message on a transmit beam to a UE. The UE may receive the PDSCH message on a receive beam, such as a latest PDSCH beam or control resource set (CORESET) beam. The UE may expect to use the same PDSCH receive beam for measuring CLI. The receive beam may be quasi-co-located (QCLed) with a transmit beam for the PDSCH message. The UE may measure CSI and CLI based at least in part on a reference signal received on the receive beam. The receive beam may be a QCL Type-D beam that corresponds to a QCL Type-D assumption, where QCL Type-D involves a spatial receive parameter or beamforming properties of a downlink receive signal. A QCL Type-D assumption may be a beam associated with information for a QCL Type-D relationship between two beams. That is, the reference signal for CLI measurement may be QCLed according to a QCL Type-D assumption.

However, another receive beam may be used for PDSCH messages, and the UE does not measure the CLI for the other beam. The other receive beam may have a lower RSRP but far less CLI, where the other receive beam would be a more optimal beam (e.g., better signal, higher throughput) than the initial receive beam.

Various aspects relate generally to measuring interference. Some aspects more specifically relate to a UE using a rule or a configuration to determine a QCL Type-D assumption for CLI measurement. The UE may receive the rule or the configuration from the network entity or obtain the rule or configuration from stored configuration information. The UE may receive a CLI resource configuration for a UE-to-UE CLI measurement resource. The UE may take CLI measurements (e.g., Layer 1 (L1)-based UE-to-UE CLI measurements) with the UE-to-UE CLI measurement resource on the determined QCL Type-D assumption (e.g., selected beam) and generate a CLI report that uses the CLI measurements. The UE may transmit the CLI report (e.g., in a CSI report) to the network entity. The CLI report may indicate the CLI measurements and the determined QCL Type-D assumption.

Particular aspects of the subject matter described in this disclosure can be implemented to realize one or more of the following potential advantages. By providing a CLI report with a QCL Type-D assumption that is determined by the rule or the configuration, the UE may assist the network entity with scheduling communications on a more optimal beam, which improves throughput and reduces latency.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

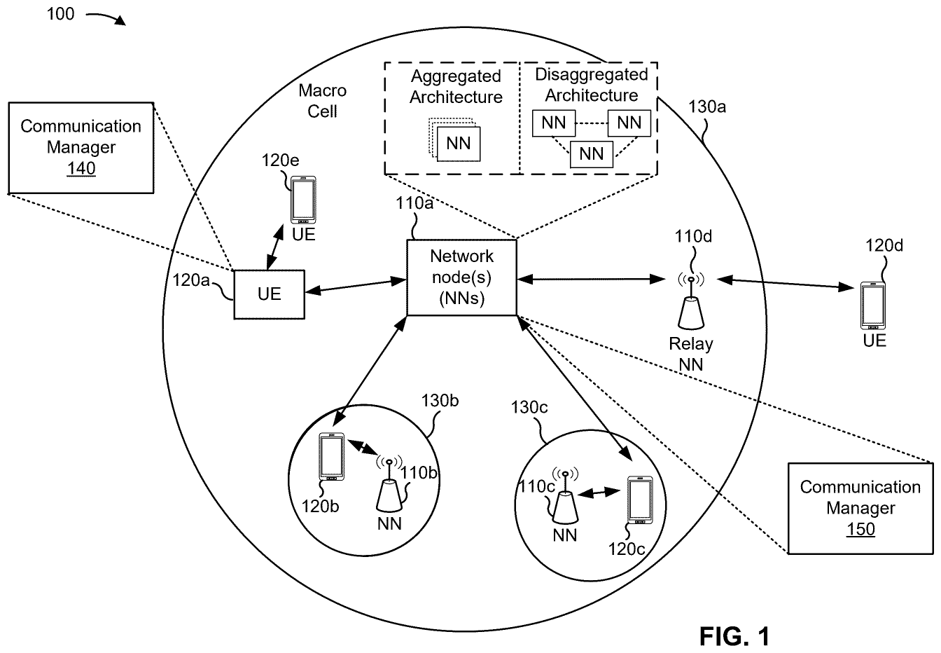

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FRI is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FRI, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUS). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (IFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more PDSCHs. Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay May receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced cMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a UE (e.g., a UE 120) may include a communication manager 140. As described in more detail elsewhere herein, the communication manager 140 may receive a CLI resource configuration for a UE-to-UE CLI measurement resource. The communication manager 140 may determine a QCL Type-D assumption per CLI resource based at least in part on a rule or a configuration associated with QCL Type-D assumption determination. The communication manager 140 may measure UE-to-UE CLI based at least in part on the determined QCL Type-D assumption per CLI resource and the CLI measurement resource. The communication manager 140 may transmit a CLI report that indicates CLI measurement results associated with the determined QCL Type-D assumption. Additionally, or alternatively, the communication manager 140 may perform one or more other operations described herein.

In some aspects, a network entity (e.g., a network node 110) may include a communication manager 150. As described in more detail elsewhere herein, the communication manager 150 may transmit a rule or a configuration associated with QCL Type-D assumption determination. The communication manager 150 may receive a CLI report that indicates CLI measurements and a determined QCL Type-D assumption. Additionally, or alternatively, the communication manager 150 may perform one or more other operations described herein.

As indicated above, FIG. 1 is provided as an example. Other examples may differ from what is described with regard to FIG. 1.

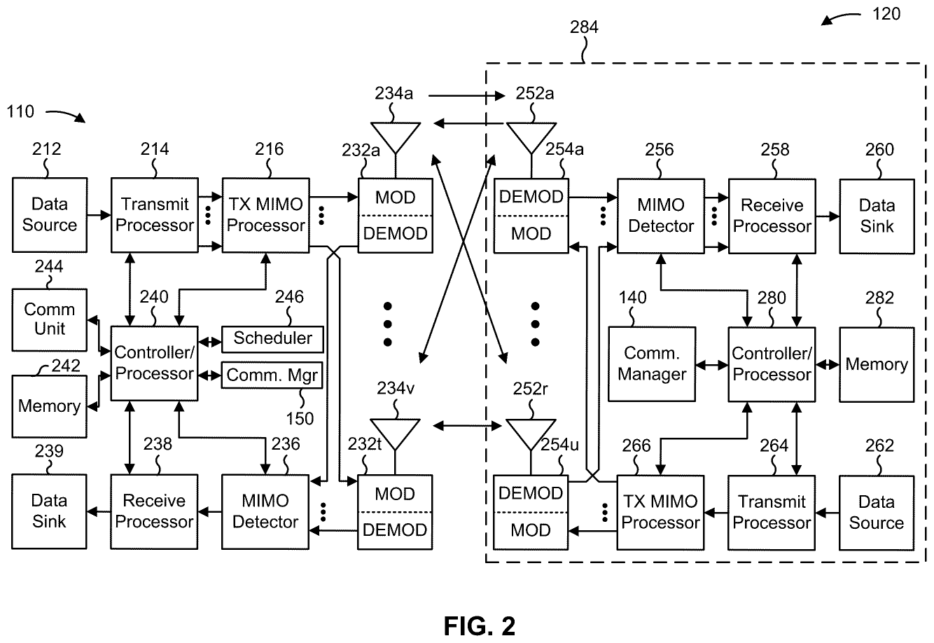

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a CSI reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include an RSRP parameter, an RSSI parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink SRS, and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

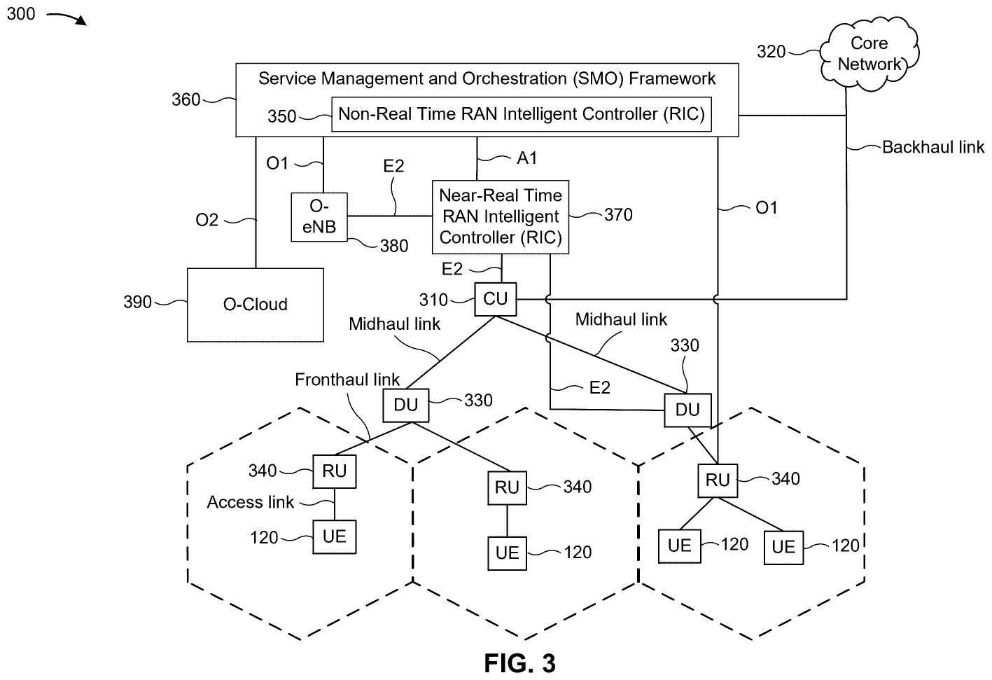

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

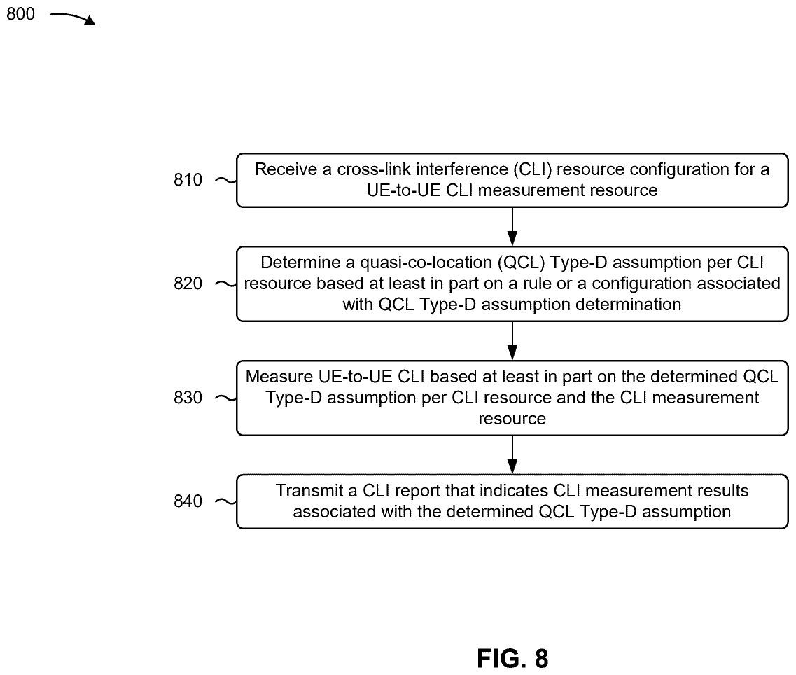

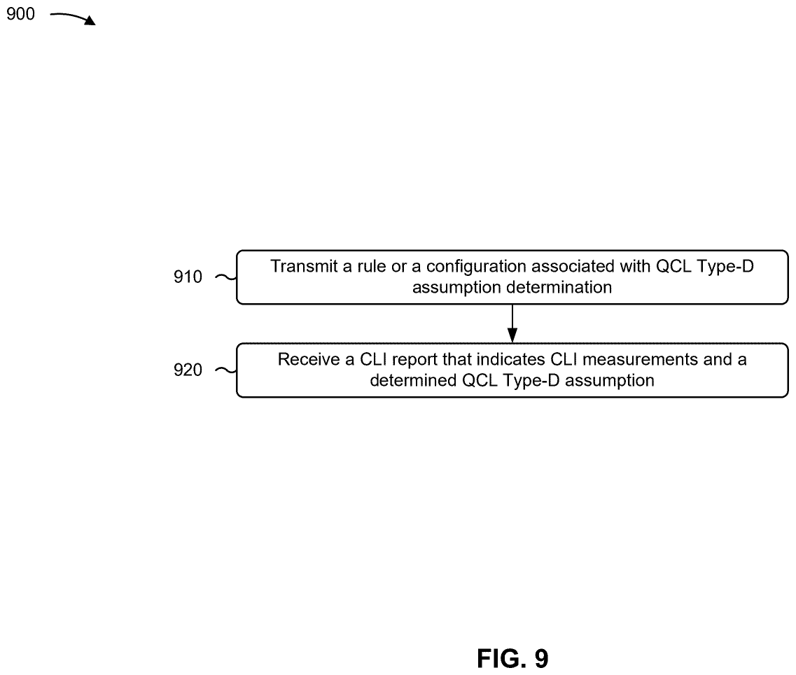

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with determining a QCL Type-D assumption for CLI measurement, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 800 of FIG. 8, process 900 of FIG. 9, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 800 of FIG. 8, process 900 of FIG. 9, or other processes as described herein. In some examples, executing instructions may include running the instructions, converting the instructions, compiling the instructions, and/or interpreting the instructions, among other examples.

In some aspects, a UE (e.g., a UE 120) includes means for receiving a CLI resource configuration for a UE-to-UE CLI measurement resource; means for determining a quasi-co-location (QCL) Type-D assumption per CLI resource based at least in part on a rule or a configuration associated with QCL Type-D assumption determination; means for measuring UE-to-UE CLI based at least in part on the determined QCL Type-D assumption per CLI resource and the CLI measurement resource; and/or means for transmitting a CLI report that indicates CLI measurement results associated with the determined QCL Type-D assumption. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., a network node 110) includes means for transmitting a rule or a configuration associated with QCL Type-D assumption determination; and/or means for receiving a CLI report that indicates CLI measurements and a determined QCL Type-D assumption. In some aspects, the means for the network entity to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

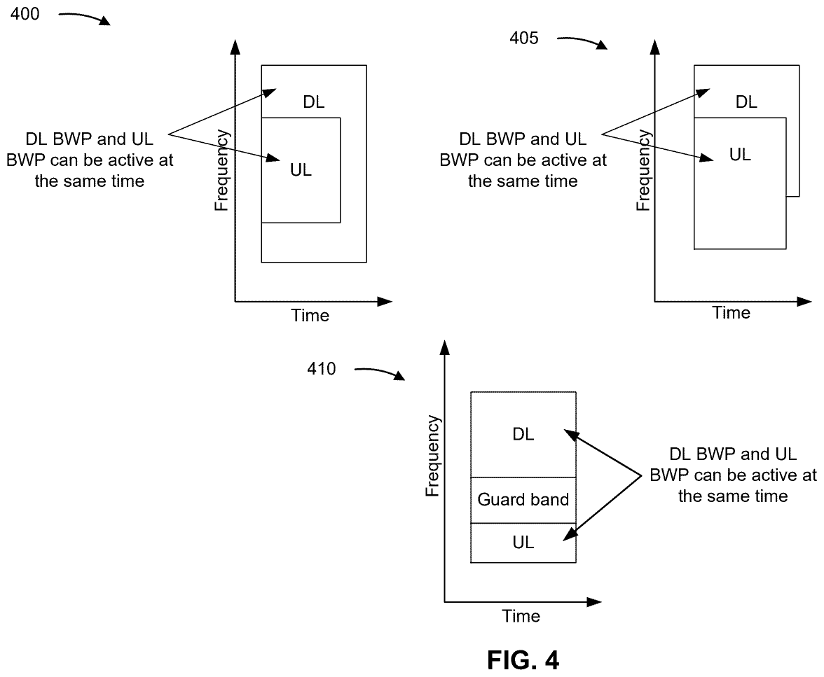

FIG. 4 is a diagram illustrating examples 400, 405, and 410 of full-duplex (FD) communication in a wireless network, in accordance with the present disclosure. “FD communication” in a wireless network refers to simultaneous bi-directional communication between devices in the wireless network. For example, a UE operating in a full-duplex mode may transmit an uplink communication and receive a downlink communication at the same time (e.g., in the same slot or the same symbol). Half-duplex communication, or “HD communication”, in a wireless network refers to unidirectional communications (e.g., only downlink communication or only uplink communication) between devices at a given time (e.g., in a given slot or a given symbol).

As shown in FIG. 4, examples 400 and 405 show examples of in-band full-duplex (IBFD) communication. In IBFD, a UE may transmit an uplink communication to a base station and receive a downlink communication from the base station on the same time and frequency resources. As shown in example 400, in a first example of IBFD, the time and frequency resources for uplink communication may fully overlap with the time and frequency resources for downlink communication. As shown in example 405, in a second example of IBFD, the time and frequency resources for uplink communication may partially overlap with the time and frequency resources for downlink communication.

As further shown in FIG. 4, example 410 shows an example of SBFD communication, which may also be referred to as “subband frequency division duplex (SBFDD)” or “flexible duplex.” In SBFD, a UE may transmit an uplink communication to a base station and receive a downlink communication from the base station at the same time, but on different frequency resources. For example, the different frequency resources may be subbands of a frequency band, such as a TDD band. In this case, the frequency resources used for downlink communication may be separated from the frequency resources used for uplink communication, in the frequency domain, by a guard band.

SBFD may increase an uplink duty cycle, improve uplink coverage, and reduce latency, because it is possible to transmit an uplink signal in an uplink subband in downlink only or in flexible slots. SBFD may enhance system capacity, resource utilization, and spectrum efficiency. SBFD may enable flexible and dynamic uplink and downlink resource adaption according to uplink and downlink traffic in a robust manner. If random access is allowed in SBFD symbols for SBFD-aware UEs (UEs capable of supporting SBFD operation), it may potentially reduce the random access latency, reduce the PRACH collision probability, and/or improve the coverage of PRACH and msg3. A random access channel (RACH) configuration may indicate a quantity of synchronization signal blocks (SSBs) per RACH occasion (RO) and power information for PRACH messages (e.g., preambles).

As indicated above, FIG. 4 is provided as an example. Other examples may differ from what is described with respect to FIG. 4.

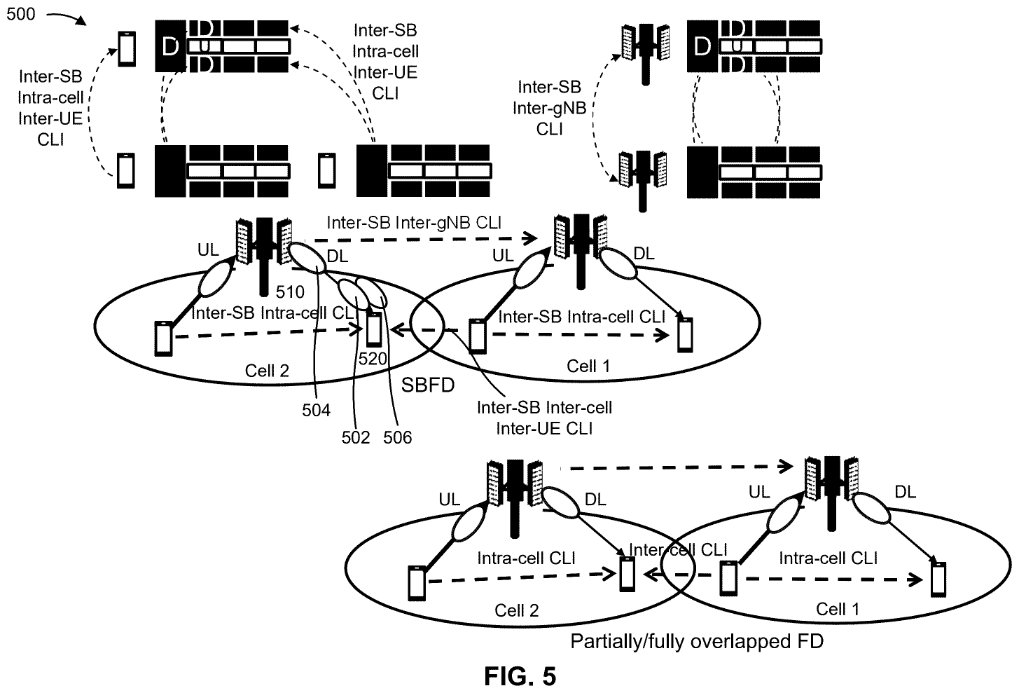

FIG. 5 is a diagram illustrating an example 500 of CLI, in accordance with the present disclosure.

When SBFD is used, there may be CLI when messages are transmitted on nearby links at the same time. There are different types of CLI. Example 500 shows, for SBFD communications, inter-subband (inter-SB) CLI between subbands, intra-cell CLI with a cell, inter-cell CLI between cells (e.g., Cell 1 and Cell 2), and inter-UE CLI between UEs. Example 500 also shows inter-gNB CLI between network entities (e.g., gNBs). For partially or fully overlapped full duplex (FD), there may be intra-cell CLI within a cell or inter-cell CLI between cells (e.g., Cell 1 and Cell 2).

The UE 520 may use a CLI measurement resource for measuring CLI. The CLI measurement resource may be an SRS-RSRP for RSRP measurements of CLI or a CLI-RSSI for RSSI measurements of CLI. A CLI framework may support both RSRP and RSSI measurements using a CLI resource configuration (e.g., SRS-ResourceConfigCLI-r16 supporting periodic SRS resources, RSSI-ResourceConfigCLI-r16). The UE 520 may take CLI measurements with the CLI measurement resource on a latest receive beam and generate a CLI report that uses the CLI measurements. The UE 520 may transmit the CLI report (e.g., in a CSI report) to the network entity 510. The CLI report may be periodic or event-based. For Event 1, the CLI becomes higher than a threshold.

A network entity 510 (e.g., gNB) may transmit a PDSCH message on a transmit beam 504 to a UE 520. The UE 520 may receive the PDSCH message on a receive beam 502, such as a latest PDSCH beam or CORESET beam (e.g., an indicated transmission configuration indicator (TCI) state for the PDSCH beam). The UE 520 may expect to use the same PDSCH receive beam (QCL Type-D) for measuring CLI. The receive beam 502 may be QCLed with a transmit beam 504 for the PDSCH message. The UE 520 may measure CSI and CLI based at least in part on a reference signal received on the receive beam 502. The receive beam 502 may be a QCL Type-D beam that corresponds to a QCL Type-D assumption, which involves a spatial receive parameter or beamforming properties of a downlink receive signal. A QCL Type-D assumption includes information for a QCL Type-D relationship between two beams. That is, the reference signal for CLI measurement may be QCLed according to a QCL Type-D assumption.

However, another receive beam 506 may be used for PDSCH messages, and the UE 520 does not measure the CLI for beam 506. Receive beam 506 may have a lower RSRP but far less CLI, where receive beam 506 would be a more optimal beam (e.g., better signal, higher throughput) than receive beam 502.

According to various aspects described herein, a UE may use a rule or a configuration to determine a QCL Type-D assumption for CLI measurement. The UE may receive the rule or the configuration from the network entity or obtain the rule or configuration from stored configuration information. The UE may receive a CLI resource configuration for a UE-to-UE CLI measurement resource. The UE may take CLI measurements (e.g., L1-based UE-to-UE CLI measurements) with the UE-to-UE CLI measurement resource on the determined QCL Type-D assumption (e.g., selected beam 506) and generate a CLI report that uses the CLI measurements. The UE may transmit the CLI report (e.g., in a CSI report) to the network entity. The CLI report may indicate the CLI measurements and the determined QCL Type-D assumption. By providing a CLI report with a QCL Type-D assumption that is determined by the rule or the configuration, the UE may assist the network entity with scheduling communications on a more optimal beam, which improves throughput and reduces latency.

As indicated above, FIG. 5 is provided as an example. Other examples may differ from what is described with regard to FIG. 5.

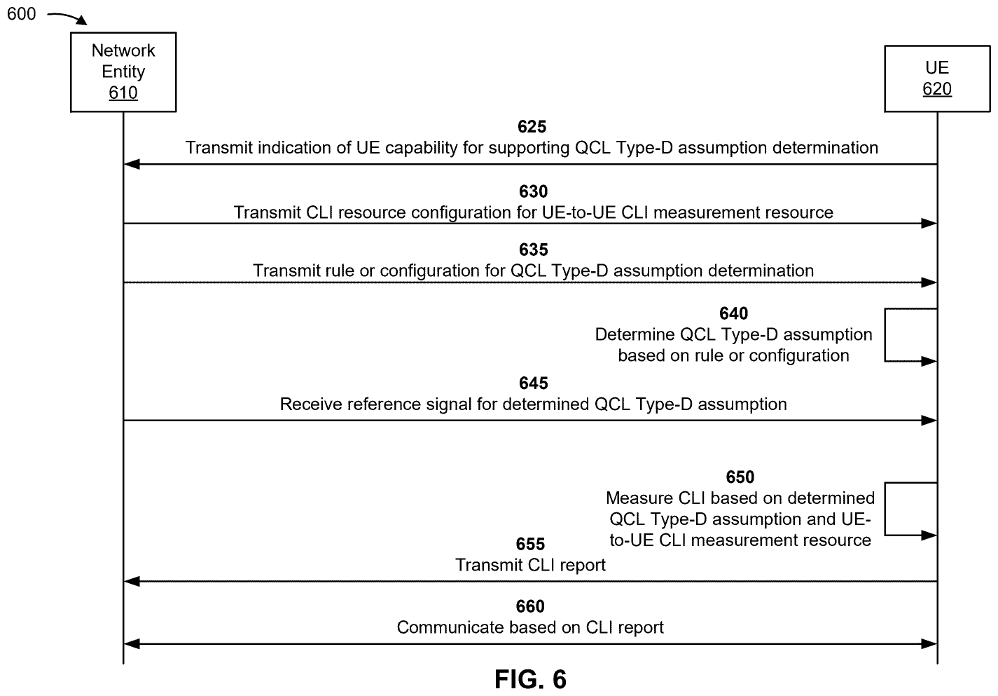

FIG. 6 is a diagram illustrating an example 600 associated with determining a QCL Type-D assumption for CLI measurement, in accordance with the present disclosure. As shown in FIG. 6, a network entity 610 (e.g., a network node 110) and a UE 620 (e.g., a UE 120) may communicate with one another via a wireless network (e.g., wireless communication network 100).

As shown by reference number 625, the UE 620 may transmit an indication (capability indication) of a UE capability for supporting QCL Type-D assumption determination for L1 UE-to-UE CLI measurement. In some aspects, the capability may include support for configuration of QCL Type-D assumption determination for an inter-UE (UE-to-UE) CLI measurement resource that uses a legacy per channel or reference signal TCI state. The capability may include support for configuration of QCL Type-D assumption determination for a UE-UE CLI measurement resource that uses a single TRP (sTRP) unified TCI state. The capability may include support for configuration of QCL Type-D assumption determination for a UE-UE CLI measurement resource that uses a multiple TRP (mTRP) unified TCI state. The capability may include support for configuration of QCL Type-D assumption determination for a UE-UE CLI measurement resource that uses both sTRP and mTRP unified TCI states. The capability may include support for configuration of QCL Type-D assumption determination for a UE-UE CLI measurement resource that uses both a legacy per channel or reference signal TCI state and/or sTRP and mTRP unified TCI states.

In some aspects, the CLI resource configuration may follow a rule that the AP CLI measurement resource and an AP CSI resource share the same AP trigger state ID space of the CLI resource configuration. There may be trigger state ID space bits (e.g., 6 bits) in DCI for the AP CLI measurement resource and the AP CSI resource. The bits may be extended (e.g., to 7 bits) with the additional bit being from a frequency domain resource allocation (FDRA) bit, a time domain resource allocation (TDRA) bit, or a reserved bit that is adjustable. The trigger state ID space may include the additional bit in a CSI request in the DCI. Alternatively, in some aspects, the AP CLI measurement resource and the AP CSI resource may be in separate trigger state ID spaces, where the DCI indicates the trigger state ID for CLI or CSI. In some aspects, an indication for the trigger state ID space for the AP CLI or the AP CSI may be located in QCL information in the CLI resource configuration (e.g., CSI AP trigger state configuration). In some aspects, the capability indication or a separate capability indication may indicate whether the UE is capable of supporting a trigger state ID space that is greater than 64 trigger states.

In some aspects, a CLI report configuration may indicate a quantity of reported CLI resources (e.g., in reportConfig) for L1-based UE-to-UE CLI measurement and reporting based on an existing CSI framework. In some aspects, a rule or configuration for CLI reporting may indicate a specific priority value (e.g., k=2) for CLI reporting. Priority values may be used when CLI reporting involves multiple CSI reporting.

As shown by reference number 630, the network entity 610 may transmit a CLI resource configuration that configures a CLI measurement resource (e.g., UE-to-UE CLI measurement resource). The UE-to-UE CLI measurement resource may be a CLI SRS signal strength resource, such as an SRS-RSRP resource or a CLI-RSSI resource. As shown by reference number 635, the network entity 610 may transmit a rule for QCL Type-D assumption determination or a configuration for QCL Type-D assumption determination. As shown by reference number 640, the UE 620 may determine a QCL Type-D assumption based at least in part on the rule or the configuration. The UE 620 may determine the QCL Type-D assumption per UE-to-UE CLI measurement resource. The UE 620 may select a QCL Type-D beam based at least in part on a transmit beam (e.g., different than PDSCH beam or CORESET beam) and the QCL Type-D assumption that pairs or links a receive beam that corresponds to the transmit beam. As shown by reference number 645, the UE 620 may receive a reference signal for the determined QCL Type-D assumption. For example, the UE 620 may receive the reference signal on the QCL Type-D beam that is derived from the determined QCL Type-D assumption.

In some aspects, the rule may be a default rule. As a first option, the rule may specify that if a QCL Type-D assumption is not configured at the UE 620 (e.g., by the network entity 610), the UE 620 may determine a QCL Type-D assumption that follows the latest PDSCH beam or CORESET beam (e.g., latest indicated TCI state) for a legacy sTRP framework. As a second option, the rule may specify that if a QCL Type-D assumption is not configured at the UE 620, the UE 620 may determine a QCL Type-D assumption that applies to the indicated TCI state for a unified TCI framework (e.g., downlink or joint TCI state). As a third option, the rule may specify that if a QCL Type-D assumption is not configured at the UE 620, and if the latest PDSCH message has two indicated TCI states for an mTRP framework, the UE 620 may determine a QCL Type-D assumption that follows the first indicated TCI state or the second indicated TCI state for an mTRP unified TCI framework. As a fourth option, if the latest PDSCH message has two indicated TCI states for an mTRP framework, the rule may specify that if a QCL Type-D assumption is not configured at the UE 620, the UE 620 may determine a QCL Type-D assumption that applies to both the first and second indicated TCI states for the mTRP unified TCI framework (e.g., two UE panels simultaneously measure CLI). As shown by reference number 650, the UE 620 may measure CLI based at least in part on the determined QCL Type-D assumption (e.g., QCL Type-D beam) and the UE-to-UE CLI measurement resource that corresponds to the QCL Type-D assumption. As shown by reference number 655, the UE 620 may transmit the CLI report (e.g., in a CSI report). As shown by reference number 660, the network entity 610 and the UE 620 may communicate based at least in part on the CLI report. For example, the network entity 610 may schedule communications on a beam with a better CLI, even if the RSRP is not as strong as an initial beam used for a previous PDSCH message.

In some aspects, a UE-to-UE CLI measurement resource may be an aperiodic (AP) CLI measurement resource. The AP CLI measurement resource may be triggered by a trigger state that is indicated or determined by the UE 620. The trigger state may be for a unified TCI framework. In some aspects, the trigger state may indicate a configured TCI state identifier (ID). In some aspects, the trigger state may indicate a flag for the QCL Type-D assumption to follow an indicated TCI state ID for CLI measurement.

In some aspects, the trigger state may be for an mTRP unified TCI framework. The trigger state may indicate a configured TCI state ID. In some aspects, the trigger state may indicate a flag for the QCL Type-D assumption to follow (or to not follow) a first indicated TCI state ID for CLI measurement. The trigger state may indicate a flag for the QCL Type-D assumption to follow (or to not follow) a second indicated TCI state ID for CLI measurement. In some aspects, the trigger state may indicate a flag for the QCL Type-D assumption to follow (or to not follow) both the first and second indicated TCI state IDs for CLI measurement. For example, the UE 620 may have two UE panels that simultaneously measure CLI. This may require a new capability for the UE.

In some aspects, the UE 620 may be configured with a CSI AP trigger state list (e.g., a CLI resource configuration). The list may include a QCL information field (e.g., qcl-info or qcl-info2). The QCL information field may include a list of references to TCI states for providing a QCL source and a QCL type of a CSI-RS resource or CSI-RS resource set. The QCL information field may be located in an information element (IE) or a parameter of the CLI resource configuration. In some aspects, the QCL information field may be included in a channel measurement resource (CMR) configuration, if the QCL information field is not included or configured in the CLI resource configuration. When the QCL information field is absent (e.g., absent from the CLI resource configuration or the CMR configuration), the UE 620 may use QCL information included in an indicated downlink only or joint TCI state.

In some aspects, a CLI resource configuration may configure a QCL Type-D assumption for an AP CLI measurement resource. The network entity 610 may configure a CMR, such as resourcesforChannel, as an optional field. Otherwise, the UE 620 may ignore the CMR. Separately, in some aspects, the network entity 610 may configure (e.g., via the CLI resource configuration) a CLI measurement resource for interference (e.g., CLI-SRS-RSRPForInterference or CLI-RSSIForInterference). The network entity 610 may define SRS-RSRP/CLI-RSSI resources or a resource set. For each SRS-RSRP/CLI-RSSI resource, the network entity 610 may configure the QCL information field (e.g., qcl-info) for an sTRP scenario. If qcl_info is not configured, a default rule may apply.

In some aspects, the UE 620 may inherit only the qel-info field in the CMR for use with a CLI measurement. For each SRS-RSRP/CLI-RSSI resource, the network entity 610 may configure the QCL information field (e.g., qcl-info) for CMR.

In some aspects, the network entity 610 may configure an AP CLI measurement resource as a CLI SRS signal strength resource (e.g., CLI SRS-RSRP/RSSI resource) as one pattern under CSI interference measurement (CSI-IM). The AP CLI measurement resource may include a CLI-RSSI pattern with contiguous resource blocks (RBs) indicated by a starting RB and a quantity of RBs. The AP CLI measurement resource may follow CSI-IM patterns (e.g., pattern 0, pattern 1). The AP CLI measurement resource may follow CSI-RS patterns in a CSI-RS pattern table (e.g., one of 18 CSI-RS patterns). In some aspects, the network entity 610 may configure qcl_info under a CSI-IM IE to measure CLI in an sTRP scenario. If qel_info is not configured, a default rule may apply. In some aspects, qcl_info under CSI-IM may only be used for CLI-IM resource.

In some aspects, if qel_info is absent for an AP CLI measurement resource, the UE 620 may determine a QCL Type-D assumption that follows the latest PDSCH beam or CORESET beam for a legacy sTRP framework. The UE 620 may determine a QCL Type-D assumption that follows QCL information in an indicated downlink only or joint TCI state. The network entity 610 may configure a flag explicitly for each CLI SRS-RSRP or RSSI resource (e.g., applyIndicated TCI-State-r19) to indicate whether to apply an indicated downlink or joint TCI state. The network entity 610 may configure a flag explicitly for each CLI SRS-RSRP or RSSI resource set (e.g., applyIndicated TCI-State-r19) to indicate whether to apply an downlink or joint indicated TCI state.

In some aspects, the UE 620 may inherit a qel_info field in CMR and use the qcl_info field for CLI measurement. The network entity 610 may configure a CLI SRS-RSRP/RSSI resource as one pattern under CSI-IM. The pattern may apply qcl_info under CMR to measure CLI in an sTRP scenario. If the qel_info is not configured, the UE 620 may use a default rule.

In some aspects, the CLI measurement resource may be a periodic (P) CLI resource. In RRC signaling, the network entity 610 may indicate the P CLI measurement resource to be a CLI-SRS-RSRP or CLI-RSSI or under CSI-IM. In some aspects, the network entity 610 may configure qcl_info for an sTRP scenario per SRS-RSRP or CLI-RSSI resource. For example, the network entity 610 may configure a TCI state ID in tci-StatesToAddModList or a unified TCI state ID in dl-OrJointTCI-StateList.

If qcl_info is not configured for a P CLI measurement resource, a default rule may apply. In some aspects, if qel_info is absent for a P CLI measurement resource, the UE 620 may follow the latest PDSCH beam or CORESET beam for a legacy sTRP framework. If qc_info is absent for a P CLI measurement resource, the UE 620 may use QCL information included in an indicated downlink only or joint TCI state. If qc_info is absent for a P CLI measurement resource, the network entity 610 may configure a flag for each CLI SRS-RSRP or RSSI resource (e.g., applyIndicatedTCI-State-r19) that indicates whether to apply an indicated downlink or joint TCI state for a QCL Type-D assumption. If qc_info is absent for a P CLI measurement resource, the network entity 610 may configure a flag for each CLI SRS-RSRP or RSSI resource set (e.g., applyIndicatedTCI-State-r19) that indicates whether to apply an indicated downlink or joint TCI state for a QCL Type-D assumption.

In some aspects, if qc_info is absent for a P CLI measurement resource in an mTRP unified TCI framework, the network entity 610 may configure a TCI state ID for the QCL Type-D assumption. The network entity 610 may configure a flag for the QCL Type-D assumption to follow a first indicated TCI state ID for CLI measurement (e.g., via applyIndicatedTCI-state, first or second TCI state IDs). The network entity 610 may configure a flag for the QCL Type-D assumption to follow a second indicated TCI state ID for CLI measurement (e.g., via applyIndicatedTCI-state2, first or second TCI state IDs). The network entity 610 may configure a flag for the QCL Type-D assumption to follow both the first and second indicated TCI state IDs for CLI measurement (e.g., two UE panels simultaneously measure CLI). This flag may be associated with a new UE capability.

As indicated above, FIG. 6 is provided as an example. Other examples may differ from what is described with respect to FIG. 6.

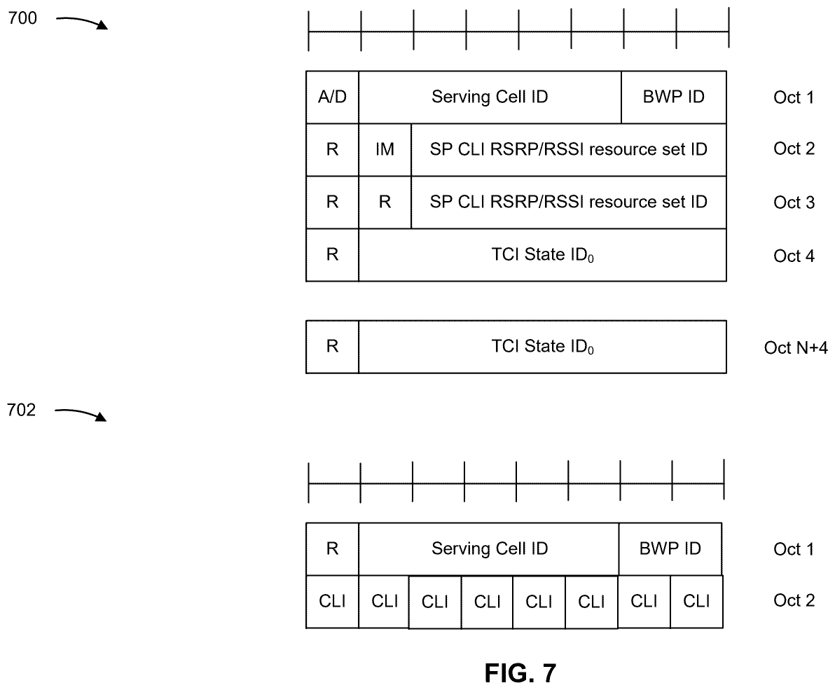

FIG. 7 is a diagram illustrating an example 700 of semi-persistent (SP) CLI resources, in accordance with the present disclosure.

In some aspects, the configuration may configure a QCL Type-D assumption for an SP CLI measurement resource. The network entity 610 may transmit a MAC-CE that activates or deactivates a new SP CLI RSRP or CLI RSSI resource set. Example 700 shows a MAC-CE that indicates a TCI state ID per CLI-RSRP/RSSI resource. If the TCI state ID may be a legacy TCI state ID (e.g., tci-StateId defined in tci-StatesToAddModList) or a TCI state ID defined in dl-OrJointTCI-StateList under a unified TCI framework, the UE 620 may expect that the indicated TCI state is not applied.

In some aspects, the configuration may configure a QCL Type-D assumption for an SP CLI measurement resource. Example 702 shows a MAC-CE that activates or deactivates up to 7 or 8 CLI (or CSI) reporting fields (e.g., up from 4 fields) that can be used to determine the QCL Type-D assumption. The reporting fields may use previously reserved fields.

As indicated above, FIG. 7 is provided as an example. Other examples may differ from what is described with regard to FIG. 7.

FIG. 8 is a diagram illustrating an example process 800 performed, for example, at a UE or an apparatus of a UE, in accordance with the present disclosure. Example process 800 is an example where the apparatus or the UE (e.g., UE 120, UE 620) performs operations associated with QCL Type-D assumption determination for CLI measurement.

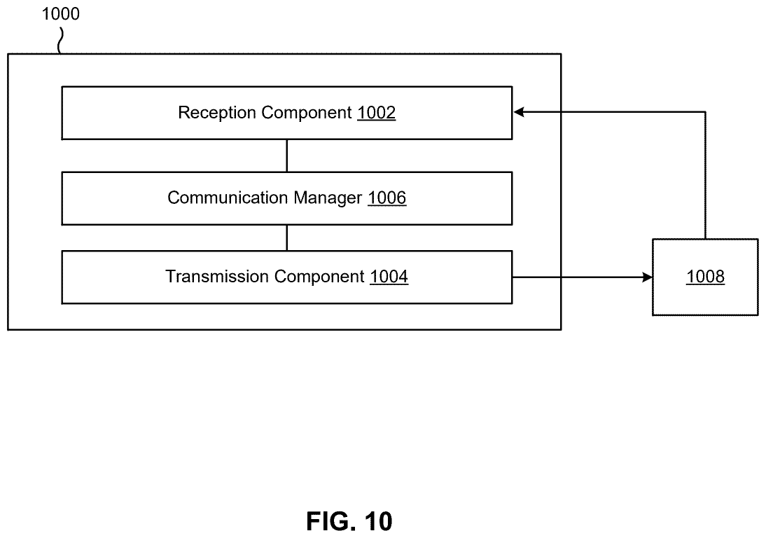

As shown in FIG. 8, in some aspects, process 800 may include receiving a CLI resource configuration for a UE-to-UE CLI measurement resource (block 810). For example, the UE (e.g., using reception component 1002 and/or communication manager 1006, depicted in FIG. 10) may receive a CLI resource configuration for a UE-to-UE CLI measurement resource, as described above.

As further shown in FIG. 8, in some aspects, process 800 may include determining a QCL Type-D assumption per CLI resource based at least in part on a rule or a configuration associated with QCL Type-D assumption determination (block 820). For example, the UE (e.g., using communication manager 1006, depicted in FIG. 10) may determine a QCL Type-D assumption per CLI resource based at least in part on a rule or a configuration associated with QCL Type-D assumption determination, as described above.

As further shown in FIG. 8, in some aspects, process 800 may include measuring UE-to-UE CLI based at least in part on the determined QCL Type-D assumption per CLI resource and the CLI measurement resource (block 830). For example, the UE (e.g., using communication manager 1006, depicted in FIG. 10) may measure UE-to-UE CLI based at least in part on the determined QCL Type-D assumption per CLI resource and the CLI measurement resource, as described above.

As further shown in FIG. 8, in some aspects, process 800 may include transmitting a CLI report that indicates CLI measurement results associated with the determined QCL Type-D assumption (block 840). For example, the UE (e.g., using transmission component 1004 and/or communication manager 1006, depicted in FIG. 10) may transmit a CLI report that indicates CLI measurement results associated with the determined QCL Type-D assumption, as described above.

Process 800 may include additional aspects, such as any single aspect or any combination of aspects described below and/or in connection with one or more other processes described elsewhere herein.

FIG. 8 is a diagram illustrating an example process 800 performed, for example, at a UE or an apparatus of a UE, in accordance with the present disclosure. Example process 800 is an example where the apparatus or the UE (e.g., UE 120, UE 620) performs operations associated with determining a QCL Type-D assumption for CLI measurement.

As shown in FIG. 8, in some aspects, process 800 may include receiving a CLI resource configuration for a UE-to-UE CLI measurement resource (block 810). For example, the UE (e.g., using reception component 1002 and/or communication manager 1006, depicted in FIG. 10) may receive a CLI resource configuration for a UE-to-UE CLI measurement resource, as described above.

As further shown in FIG. 8, in some aspects, process 800 may include determining a QCL Type-D assumption per CLI resource based at least in part on a rule or a configuration associated with QCL Type-D assumption determination (block 820). For example, the UE (e.g., using communication manager 1006, depicted in FIG. 10) may determine a QCL Type-D assumption per CLI resource based at least in part on a rule or a configuration associated with QCL Type-D assumption determination, as described above.

As further shown in FIG. 8, in some aspects, process 800 may include measuring UE-to-UE CLI based at least in part on the determined QCL Type-D assumption per CLI resource and the UE-to-UE CLI measurement resource (block 830). For example, the UE (e.g., using communication manager 1006, depicted in FIG. 10) may measure UE-to-UE CLI based at least in part on the determined QCL Type-D assumption per CLI resource and the UE-to-UE CLI measurement resource, as described above.

As further shown in FIG. 8, in some aspects, process 800 may include transmitting a CLI report that indicates CLI measurement results associated with the determined QCL Type-D assumption (block 840). For example, the UE (e.g., using transmission component 1004 and/or communication manager 1006, depicted in FIG. 10) may transmit a CLI report that indicates CLI measurement results associated with the determined QCL Type-D assumption, as described above.

Process 800 may include additional aspects, such as any single aspect or any combination of aspects described below and/or in connection with one or more other processes described elsewhere herein.

In a first aspect, the CLI measurements are L1-based UE-to-UE CLI measurements.

In a second aspect, alone or in combination with the first aspect, the UE-to-UE CLI measurement resource includes a CLI-RSSI resource or an SRS-RSRP resource.

In a third aspect, alone or in combination with one or more of the first and second aspects, the rule specifies that if a QCL Type-D assumption is not configured at the UE, the UE determines the QCL Type-D assumption based at least in part on a latest TCI state indicated for a physical downlink shared channel or a CORESET.

In a fourth aspect, alone or in combination with one or more of the first through third aspects, the rule specifies that if a QCL Type-D assumption is not configured at the UE, the UE determines the QCL Type-D assumption based at least in part on an indicated TCI state indicated for a unified TCI framework.

In a fifth aspect, alone or in combination with one or more of the first through fourth aspects, the rule specifies that if a QCL Type-D assumption is not configured at the UE, and if a latest PDSCH has two indicated TCI states, the UE determines the QCL Type-D assumption based at least in part on a first indicated TCI state or a second indicated TCI state for an mTRP unified TCI framework.

In a sixth aspect, alone or in combination with one or more of the first through fifth aspects, the rule specifies that if a QCL Type-D assumption is not configured at the UE, and if a latest PDSCH has two indicated TCI states, the UE determines the QCL Type-D assumption based at least in part on both a first indicated TCI state and a second indicated TCI state for an mTRP unified TCI framework.

In a seventh aspect, alone or in combination with one or more of the first through sixth aspects, process 800 includes transmitting an indication of a UE capability for supporting configuration of the UE with a QCL Type-D assumption for the CLI measurement resource.

In an eighth aspect, alone or in combination with one or more of the first through seventh aspects, the UE-to-UE CLI measurement resource is an L1 CLI measurement resource that is used with an indicated TCI state per channel or reference signal.

In a ninth aspect, alone or in combination with one or more of the first through eighth aspects, the UE-to-UE CLI measurement resource is an L1 CLI measurement resource that is used with an sTRP unified TCI state.

In a tenth aspect, alone or in combination with one or more of the first through ninth aspects, the UE-to-UE CLI measurement resource is an L1 CLI measurement resource that is used with an mTRP unified TCI state.

In an eleventh aspect, alone or in combination with one or more of the first through tenth aspects, the UE-to-UE CLI measurement resource is an L1 CLI measurement resource that is used with an sTRP unified TCI state and an mTRP unified TCI state.

In a twelfth aspect, alone or in combination with one or more of the first through eleventh aspects, the UE-to-UE CLI measurement resource is an L1 CLI measurement resource that is used with an indicated TCI state per channel or reference signal or both an sTRP unified TCI state and an mTRP unified TCI state.

In a thirteenth aspect, alone or in combination with one or more of the first through twelfth aspects, the UE-to-UE CLI measurement resource is an AP CLI measurement resource triggered by a trigger state.

In a fourteenth aspect, alone or in combination with one or more of the first through thirteenth aspects, the trigger state indicates a configured TCI state ID for the QCL Type-D assumption.

In a fifteenth aspect, alone or in combination with one or more of the first through fourteenth aspects, the trigger state indicates a flag for the QCL Type-D assumption to follow an indicated TCI state ID for CLI measurement or to not follow the indicated TCI state ID for CLI measurement.

In a sixteenth aspect, alone or in combination with one or more of the first through fifteenth aspects, the unified TCI framework an mTRP unified TCI framework, and the trigger state indicates a configured TCI state ID for the QCL Type-D assumption.

In a seventeenth aspect, alone or in combination with one or more of the first through sixteenth aspects, the unified TCI framework is an mTRP unified TCI framework, and the trigger state indicates a flag for the QCL Type-D assumption to follow a first indicated TCI state ID for CLI measurement.

In an eighteenth aspect, alone or in combination with one or more of the first through seventeenth aspects, the unified TCI framework is an mTRP unified TCI framework, and the trigger state indicates a flag for the QCL Type-D assumption to follow a second indicated TCI state ID for CLI measurement.

In a nineteenth aspect, alone or in combination with one or more of the first through eighteenth aspects, the unified TCI framework is an mTRP unified TCI framework, and the trigger state indicates a flag for the QCL Type-D assumption to follow a first indicated TCI state ID and a second indicated TCI state ID for CLI measurement.

In a twentieth aspect, alone or in combination with one or more of the first through nineteenth aspects, the rule or the configuration specifies that the network entity is to not configure a CMR configuration or the UE is to ignore the CMR configuration.

In a twenty-first aspect, alone or in combination with one or more of the first through twentieth aspects, the rule or the configuration specifies that the CMR configuration is optionally configured based at least in part on a CLI-RSSI resource or an SRS-RSRP resource indicated in a report quantity parameter.

In a twenty-second aspect, alone or in combination with one or more of the first through twenty-first aspects, the rule or the configuration specifies that if the CMR configuration is configured, the UE is to ignore the configuration based at least in part on a CLI-RSSI resource or an SRS-RSRP resource indicated in a report quantity parameter.

In a twenty-third aspect, alone or in combination with one or more of the first through twenty-second aspects, the rule or the configuration specifies that the UE is to either configuring a CMR with a CMR configuration or using a QCL information field in the CMR configuration for CLI measurement and ignore other fields of the CMR configuration.

In a twenty-fourth aspect, alone or in combination with one or more of the first through twenty-third aspects, the CLI resource configuration configures the UE-to-UE CLI measurement resource via a UE-to-UE CLI measurement resource for interference field.

In a twenty-fifth aspect, alone or in combination with one or more of the first through twenty-fourth aspects, the UE-to-UE CLI measurement resource is a CLI-RSSI resource or an SRS-RSRP resource.

In a twenty-sixth aspect, alone or in combination with one or more of the first through twenty-fifth aspects, the CLI resource configuration configures the CLI-RSSI resource or the SRS-RSRP resource with a QCL information field.

In a twenty-seventh aspect, alone or in combination with one or more of the first through twenty-sixth aspects, the CLI-RSSI resource or the SRS-RSRP resource is configured under a CSI-IM resource IE.

In a twenty-eighth aspect, alone or in combination with one or more of the first through twenty-seventh aspects, the CLI-RSSI resource or the SRS-RSRP resource follows a pattern associated with a CSI-IM resource pattern.

In a twenty-ninth aspect, alone or in combination with one or more of the first through twenty-eighth aspects, the pattern is a CLI-RSSI pattern with contiguous resource blocks, is a specified CSI-IM pattern, is a comb pattern, or follows a CSI-RS pattern of a CSI-RS pattern table.

In a thirtieth aspect, alone or in combination with one or more of the first through twenty-ninth aspects, the pattern is associated with a QCL information field associated with the CSI-IM IE.

In a thirty-first aspect, alone or in combination with one or more of the first through thirtieth aspects, the QCL information field is dedicated to specifying the UE-to-UE CLI measurement resource.

In a thirty-second aspect, alone or in combination with one or more of the first through thirty-first aspects, a QCL information field is absent from the CLI resource configuration, and the pattern is associated with a latest PUSCH or a latest CORESET beam of a single transmit receive point framework.

In a thirty-third aspect, alone or in combination with one or more of the first through thirty-second aspects, the pattern follows QCL information associated with an indicated downlink or joint TCI state.

In a thirty-fourth aspect, alone or in combination with one or more of the first through thirty-third aspects, the rule or the configuration indicates a flag per CLI-RSSI resource or SRS-RSRP resource that indicates whether to apply an indicated downlink or joint TCI state.

In a thirty-fifth aspect, alone or in combination with one or more of the first through thirty-fourth aspects, the rule or the configuration indicates a flag per CLI-RSSI resource set or SRS-RSRP resource set that indicates whether to apply an indicated downlink or joint TCI state.

In a thirty-sixth aspect, alone or in combination with one or more of the first through thirty-fifth aspects, the CLI-RSSI resource or the SRS-RSRP resource applies QCL information of a CMR configuration.

In a thirty-seventh aspect, alone or in combination with one or more of the first through thirty-sixth aspects, the CLI-RSSI resource or the SRS-RSRP resource applies QCL information associated with the CSI-IM resource pattern.

In a thirty-eighth aspect, alone or in combination with one or more of the first through thirty-seventh aspects, the CLI resource configuration follows a rule that the AP CLI measurement resource and an AP CSI resource share a same trigger state ID space of the CLI resource configuration.

In a thirty-ninth aspect, alone or in combination with one or more of the first through thirty-eighth aspects, the trigger state ID space includes an additional bit in a CSI request in DCI for the AP CLI measurement resource and the AP CSI resource.

In a fortieth aspect, alone or in combination with one or more of the first through thirty-ninth aspects, process 800 includes transmitting a capability indication that indicates whether the UE is capable of supporting a trigger state ID space that is greater than 64 trigger states.

In a forty-first aspect, alone or in combination with one or more of the first through fortieth aspects, the CLI resource configuration indicates the AP CLI measurement resource and an AP CSI resource in separate trigger state ID spaces of the CLI resource configuration.

In a forty-second aspect, alone or in combination with one or more of the first through forty-first aspects, a CLI report configuration indicates a quantity of reported CLI resources.

In a forty-third aspect, alone or in combination with one or more of the first through forty-second aspects, a rule or a configuration for CLI reporting indicates a specific priority value for CLI reporting.

In a forty-fourth aspect, alone or in combination with one or more of the first through forty-third aspects, the UE-to-UE CLI measurement resource is a periodic CLI measurement resource configured with a QCL information field via RRC signaling.

In a forty-fifth aspect, alone or in combination with one or more of the first through forty-fourth aspects, the UE-to-UE CLI measurement resource is a periodic CLI measurement resource, where a QCL information field is absent from the CLI resource configuration, and the QCL Type-D assumption is based at least in part on a latest PDSCH beam or a latest CORESET beam for an sTRP framework.

In a forty-sixth aspect, alone or in combination with one or more of the first through forty-fifth aspects, the UE-to-UE CLI measurement resource is a periodic CLI measurement resource, where a QCL information field is absent from the CLI resource configuration, and the QCL Type-D assumption is based at least in part on QCL information included in an indicated downlink or joint TCI state.

In a forty-seventh aspect, alone or in combination with one or more of the first through forty-sixth aspects, the UE-to-UE CLI measurement resource is a periodic CLI measurement resource, where a QCL information field is absent from the CLI resource configuration, and the rule or the configuration configures a flag per UE-to-UE CLI measurement resource that indicates whether to apply an indicated downlink or joint TCI state for the QCL Type-D assumption.

In a forty-eighth aspect, alone or in combination with one or more of the first through forty-seventh aspects, the UE-to-UE CLI measurement resource is a periodic CLI measurement resource, where a QCL information field is absent from the CLI resource configuration, and the rule or the configuration configures a flag per UE-to-UE CLI measurement resource set that indicates whether to apply an indicated downlink or joint TCI state for the QCL Type-D assumption.

In a forty-ninth aspect, alone or in combination with one or more of the first through forty-eighth aspects, the UE-to-UE CLI measurement resource is a periodic CLI measurement resource, where a QCL information field is absent from the CLI resource configuration, and the rule or the configuration configures a downlink or joint TCI state ID of an mTRP framework for the QCL Type-D assumption.

In a fiftieth aspect, alone or in combination with one or more of the first through forty-ninth aspects, the UE-to-UE CLI measurement resource is a periodic CLI measurement resource, where a QCL information field is absent from the CLI resource configuration, and the rule or the configuration configures a flag for the QCL Type-D assumption to follow a first indicated downlink or joint TCI state ID for the CLI measurement.

In a fifty-first aspect, alone or in combination with one or more of the first through fiftieth aspects, the UE-to-UE CLI measurement resource is a periodic CLI measurement resource, where a QCL information field is absent from the CLI resource configuration, and the rule or the configuration configures a flag for the QCL Type-D assumption to follow a second indicated downlink or joint TCI state ID for the CLI measurement.

In a fifty-second aspect, alone or in combination with one or more of the first through fifty-first aspects, the UE-to-UE CLI measurement resource is a periodic CLI measurement resource, where a QCL information field is absent from the CLI resource configuration, and the rule or the configuration configures a flag for the QCL Type-D assumption to follow a first indicated downlink or joint TCI state ID and a second indicated downlink or joint TCI state ID for the CLI measurement.

In a fifty-third aspect, alone or in combination with one or more of the first through fifty-second aspects, the UE-to-UE CLI measurement resource is an SP CLI measurement resource, and process 800 includes receiving a MAC-CE that semi-persistent activates or deactivates the CLI-RSSI resource set or an SRS-RSRP resource set.

In a fifty-fourth aspect, alone or in combination with one or more of the first through fifty-third aspects, the rule or the configuration specifies that an indicated TCI state ID in the MAC-CE is not applied if the TCI state ID is defined in a TCI states to add list or a downlink or joint TCI state list under the unified TCI framework. In some aspects, the TCI state ID is configured per CLI received signal strength indicator resource or resource set or per sounding reference signal reference signal received power measurement resource or resource set.

In a fifty-fifth aspect, alone or in combination with one or more of the first through fifty-fourth aspects, the MAC-CE activates or deactivates SP CSI reporting on a PUCCH. In some aspects, the MAC-CE includes more than 4 fields that activate or deactivate more than 4 CSI or CLI reporting resources or resource sets.

In a fifty-sixth aspect, alone or in combination with one or more of the first through fifty-fifth aspects, the UE-to-UE CLI measurement resource is an SP CLI measurement resource, and transmitting the CLI report includes transmitting the CLI report via a CSI reporting configuration.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network entity or an apparatus of a network entity, in accordance with the present disclosure. Example process 900 is an example where the apparatus or the network entity (e.g., network node 110, network entity 610) performs operations associated with determining a QCL Type-D assumption for CLI measurement.

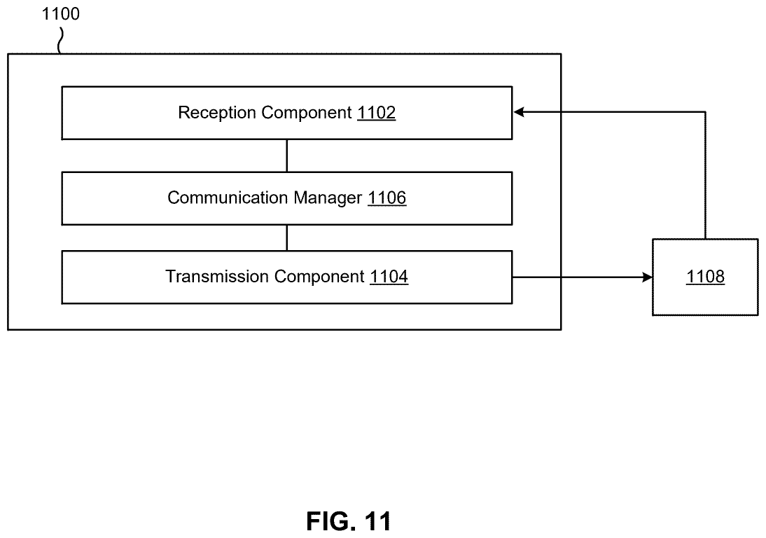

As shown in FIG. 9, in some aspects, process 900 may include transmitting a rule or a configuration associated with QCL Type-D assumption determination (block 910). For example, the network entity (e.g., using transmission component 1104 and/or communication manager 1106, depicted in FIG. 11) may transmit a rule or a configuration associated with QCL Type-D assumption determination, as described above.

As further shown in FIG. 9, in some aspects, process 900 may include receiving a CLI report that indicates CLI measurements and a determined QCL Type-D assumption (block 920). For example, the network entity (e.g., using reception component 1102 and/or communication manager 1106, depicted in FIG. 11) may receive a CLI report that indicates CLI measurements and a determined QCL Type-D assumption, as described above.

Process 900 may include additional aspects, such as any single aspect or any combination of aspects described below and/or in connection with one or more other processes described elsewhere herein.

In a first aspect, the CLI measurements are L1-based UE-to-UE CLI measurements.

In a second aspect, alone or in combination with the first aspect, process 900 includes transmitting a CLI resource configuration for a UE-to-UE CLI measurement resource, where the UE-to-UE CLI measurement resource includes a CLI-RSSI resource or an SRS-RSRP resource.

In a third aspect, alone or in combination with one or more of the first and second aspects, the rule specifies that if a QCL Type-D assumption is not configured at a UE, the UE determines the QCL Type-D assumption based at least in part on a latest TCI state indicated for a PDSCH or a CORESET.

In a fourth aspect, alone or in combination with one or more of the first through third aspects, the rule specifies that if a QCL Type-D assumption is not configured at a UE, the UE determines the QCL Type-D assumption based at least in part on an indicated TCI state indicated for a unified TCI framework.

In a fifth aspect, alone or in combination with one or more of the first through fourth aspects, the rule specifies that if a QCL Type-D assumption is not configured at a UE, and if a latest PDSCH has two indicated TCI states, the UE determines the QCL Type-D assumption based at least in part on a first indicated TCI state or a second indicated TCI state for an mTRP unified TCI framework.

In a sixth aspect, alone or in combination with one or more of the first through fifth aspects, the rule specifies that if a QCL Type-D assumption is not configured at a UE, and if a latest PDSCH has two indicated TCI states, the UE determines the QCL

Type-D assumption based at least in part on both a first indicated TCI state and a second indicated TCI state for an mTRP unified TCI framework.

In a seventh aspect, alone or in combination with one or more of the first through sixth aspects, process 900 includes receiving an indication of a UE capability for supporting configuration of the UE with a QCL Type-D assumption for the CLI measurement resource.

In an eighth aspect, alone or in combination with one or more of the first through seventh aspects, process 900 includes transmitting a CLI resource configuration for a UE-to-UE CLI measurement resource, where the UE-to-UE CLI measurement resource is an L1 CLI measurement resource that is used with an indicated TCI state per channel or reference signal.

In a ninth aspect, alone or in combination with one or more of the first through eighth aspects, process 900 includes transmitting a CLI resource configuration for a UE-to-UE CLI measurement resource, where the UE-to-UE CLI measurement resource is an L1 CLI measurement resource that is used with an sTRP unified TCI state.

In a tenth aspect, alone or in combination with one or more of the first through ninth aspects, process 900 includes transmitting a CLI resource configuration for a UE-to-UE CLI measurement resource, where the UE-to-UE CLI measurement resource is an L1 CLI measurement resource that is used with an mTRP unified TCI state.

In an eleventh aspect, alone or in combination with one or more of the first through tenth aspects, process 900 includes transmitting a CLI resource configuration for a UE-to-UE CLI measurement resource, where the UE-to-UE CLI measurement resource is an L1 CLI measurement resource that is used with an sTRP unified TCI state and a multiple TRP unified TCI state.

In a twelfth aspect, alone or in combination with one or more of the first through eleventh aspects, process 900 includes transmitting a CLI resource configuration for a UE-to-UE CLI measurement resource, where the UE-to-UE CLI measurement resource is an L1 CLI measurement resource that is used with an indicated TCI state per channel or reference signal or both a single TRP unified TCI state and an mTRP unified TCI state.

In a thirteenth aspect, alone or in combination with one or more of the first through twelfth aspects, process 900 includes transmitting a CLI resource configuration for a UE-to-UE CLI measurement resource, where the UE-to-UE CLI measurement resource is an AP CLI measurement resource triggered by a trigger state.

In a fourteenth aspect, alone or in combination with one or more of the first through thirteenth aspects, the trigger state indicates a configured TCI state ID for the QCL Type-D assumption.

In a fifteenth aspect, alone or in combination with one or more of the first through fourteenth aspects, the trigger state indicates a flag for the QCL Type-D assumption to follow an indicated TCI state ID for CLI measurement or to not follow the indicated TCI state ID for CLI measurement.

In a sixteenth aspect, alone or in combination with one or more of the first through fifteenth aspects, the unified TCI framework is an mTRP unified TCI framework, and wherein the trigger state indicates a configured TCI state ID for the QCL Type-D assumption.

In a seventeenth aspect, alone or in combination with one or more of the first through sixteenth aspects, the unified TCI framework is an mTRP unified TCI framework, and the trigger state indicates a flag for the QCL Type-D assumption to follow a first indicated TCI state ID for CLI measurement.

In an eighteenth aspect, alone or in combination with one or more of the first through seventeenth aspects, the unified TCI framework is an mTRP unified TCI framework, and the trigger state indicates a flag for the QCL Type-D assumption to follow a second indicated TCI state ID for CLI measurement.

In a nineteenth aspect, alone or in combination with one or more of the first through eighteenth aspects, the unified TCI framework is an mTRP unified TCI framework, and the trigger state indicates a flag for the QCL Type-D assumption to follow a first indicated TCI state ID and a second indicated TCI state ID for CLI measurement.

In a twentieth aspect, alone or in combination with one or more of the first through nineteenth aspects, the rule or the configuration specifies that the network entity is to not configure a CMR configuration or the UE is to ignore the CMR configuration.

In a twenty-first aspect, alone or in combination with one or more of the first through twentieth aspects, the rule or the configuration specifies that the CMR configuration is optionally configured based at least in part on a CLI-RSSI resource or an SRS-RSRP resource indicated in a report quantity parameter.

In a twenty-second aspect, alone or in combination with one or more of the first through twenty-first aspects, the rule or the configuration specifies that if the CMR configuration is configured, the UE is to ignore the configuration based at least in part on a CLI-RSSI resource or an SRS-RSRP resource indicated in a report quantity parameter.

In a twenty-third aspect, alone or in combination with one or more of the first through twenty-second aspects, the rule or the configuration specifies that the UE is to either configuring a CMR with a CMR configuration or using a QCL information field in the CMR configuration for CLI measurement and ignore other fields of the CMR configuration.

In a twenty-fourth aspect, alone or in combination with one or more of the first through twenty-third aspects, the CLI resource configuration configures the UE-to-UE CLI measurement resource via a UE-to-UE CLI measurement resource for interference field.

In a twenty-fifth aspect, alone or in combination with one or more of the first through twenty-fourth aspects, the UE-to-UE CLI measurement resource is a CLI-RSSI resource or an SRS-RSRP resource.

In a twenty-sixth aspect, alone or in combination with one or more of the first through twenty-fifth aspects, the CLI resource configuration configures the CLI-RSSI resource or the SRS-RSRP resource with a QCL information field.

In a twenty-seventh aspect, alone or in combination with one or more of the first through twenty-sixth aspects, the CLI-RSSI resource or the SRS-RSRP resource is configured under a CSI-IM resource IE.

In a twenty-eighth aspect, alone or in combination with one or more of the first through twenty-seventh aspects, the CLI-RSSI resource or the SRS-RSRP resource follows a pattern associated with a CSI-IM resource pattern.

In a twenty-ninth aspect, alone or in combination with one or more of the first through twenty-eighth aspects, the pattern is a CLI-RSSI pattern with contiguous resource blocks, is a specified CSI-IM pattern, is a comb pattern, or follows a CSI-RS pattern of a CSI-RS pattern table.

In a thirtieth aspect, alone or in combination with one or more of the first through twenty-ninth aspects, the pattern is associated with a QCL information field associated with the CSI-IM IE.

In a thirty-first aspect, alone or in combination with one or more of the first through thirtieth aspects, the QCL information field is dedicated to specifying the UE-to-UE CLI measurement resource.

In a thirty-second aspect, alone or in combination with one or more of the first through thirty-first aspects, a QCL information field is absent from the CLI resource configuration, and wherein the pattern is associated with a latest PDSCH beam or a latest CORESET beam of an sTRP framework.

In a thirty-third aspect, alone or in combination with one or more of the first through thirty-second aspects, the pattern follows QCL information associated with an indicated downlink or joint TCI state.

In a thirty-fourth aspect, alone or in combination with one or more of the first through thirty-third aspects, the rule or the configuration indicates a flag per CLI-RSSI resource or SRS-RSRP resource that indicates whether to apply an indicated downlink or joint TCI state.

In a thirty-fifth aspect, alone or in combination with one or more of the first through thirty-fourth aspects, the rule or the configuration indicates a flag per CLI-RSSI resource set or SRS-RSRP resource set that indicates whether to apply an indicated downlink or joint TCI state.

In a thirty-sixth aspect, alone or in combination with one or more of the first through thirty-fifth aspects, the CLI-RSSI resource or the SRS-RSRP resource applies QCL information of a CMR configuration.

In a thirty-seventh aspect, alone or in combination with one or more of the first through thirty-sixth aspects, the CLI-RSSI resource or the SRS-RSRP resource applies QCL information associated with the CSI-IM resource pattern.

In a thirty-eighth aspect, alone or in combination with one or more of the first through thirty-seventh aspects, the CLI resource configuration follows a rule that the AP CLI measurement resource and an AP CSI resource share a same trigger state ID space of the CLI resource configuration.

In a thirty-ninth aspect, alone or in combination with one or more of the first through thirty-eighth aspects, the trigger state ID space includes an additional bit in a CSI request in DCI for the AP CLI measurement resource and the AP CSI resource.

In a fortieth aspect, alone or in combination with one or more of the first through thirty-ninth aspects, process 900 includes transmitting a capability indication that indicates whether the UE is capable of supporting a trigger state ID space that is greater than 64 trigger states.

In a forty-first aspect, alone or in combination with one or more of the first through fortieth aspects, the CLI resource configuration indicates the AP CLI measurement resource and an AP CSI resource in separate trigger state ID spaces of the CLI resource configuration.

In a forty-second aspect, alone or in combination with one or more of the first through forty-first aspects, a CLI report configuration indicates a quantity of reported CLI resources.

In a forty-third aspect, alone or in combination with one or more of the first through forty-second aspects, a rule or a configuration for CLI reporting indicates a specific priority value for CLI reporting.

In a forty-fourth aspect, alone or in combination with one or more of the first through forty-third aspects, process 900 includes transmitting a CLI resource configuration for a UE-to-UE CLI measurement resource, where the UE-to-UE CLI measurement resource is a periodic CLI measurement resource configured with a QCL information field via RRC signaling.

In a forty-fifth aspect, alone or in combination with one or more of the first through forty-fourth aspects, process 900 includes transmitting a CLI resource configuration for a UE-to-UE CLI measurement resource, where the UE-to-UE CLI measurement resource is a periodic CLI measurement resource, where a QCL information field is absent from the CLI resource configuration, and the QCL Type-D assumption is based at least in part on a latest PDSCH beam or a latest CORESET beam for an sTRP framework.

In a forty-sixth aspect, alone or in combination with one or more of the first through forty-fifth aspects, process 900 includes transmitting a CLI resource configuration for a UE-to-UE CLI measurement resource, where the UE-to-UE CLI measurement resource is a periodic CLI measurement resource, a QCL information field is absent from the CLI resource configuration, and the QCL Type-D assumption is based at least in part on QCL information included in an indicated downlink or joint TCI state.

In a forty-seventh aspect, alone or in combination with one or more of the first through forty-sixth aspects, process 900 includes transmitting a CLI resource configuration for a UE-to-UE CLI measurement resource, where the UE-to-UE CLI measurement resource is a periodic CLI measurement resource, a QCL information field is absent from the CLI resource configuration, and the rule or the configuration configures a flag per UE-to-UE CLI measurement resource that indicates whether to apply an indicated downlink or joint transmission configuration indicator state for the QCL Type-D assumption.

In a forty-eighth aspect, alone or in combination with one or more of the first through forty-seventh aspects, process 900 includes transmitting a CLI resource configuration for a UE-to-UE CLI measurement resource, where the UE-to-UE CLI measurement resource is a periodic CLI measurement resource, a QCL information field is absent from the CLI resource configuration, and the rule or the configuration configures a flag per UE-to-UE CLI measurement resource set that indicates whether to apply an indicated downlink or joint transmission configuration indicator state for the QCL Type-D assumption.

In a forty-ninth aspect, alone or in combination with one or more of the first through forty-eighth aspects, process 900 includes transmitting a CLI resource configuration for a UE-to-UE CLI measurement resource, where the UE-to-UE CLI measurement resource is a periodic CLI measurement resource, a QCL information field is absent from the CLI resource configuration, and the rule or the configuration configures a downlink or joint TCI state ID of an mTRP framework for the QCL Type-D assumption.

In a fiftieth aspect, alone or in combination with one or more of the first through forty-ninth aspects, process 900 includes transmitting a CLI resource configuration for a UE-to-UE CLI measurement resource, where the UE-to-UE CLI measurement resource is a periodic CLI measurement resource, a QCL information field is absent from the CLI resource configuration, and the rule or the configuration configures a flag for the QCL Type-D assumption to follow a first indicated downlink or joint TCI state ID for the CLI measurement.

In a fifty-first aspect, alone or in combination with one or more of the first through fiftieth aspects, process 900 includes transmitting a CLI resource configuration for a UE-to-UE CLI measurement resource, where the UE-to-UE CLI measurement resource is a periodic CLI measurement resource, a QCL information field is absent from the CLI resource configuration, and the rule or the configuration configures a flag for the QCL Type-D assumption to follow a second indicated downlink or joint TCI state ID for the CLI measurement.

In a fifty-second aspect, alone or in combination with one or more of the first through fifty-first aspects, process 900 includes transmitting a CLI resource configuration for a UE-to-UE CLI measurement resource, where the UE-to-UE CLI measurement resource is a periodic CLI measurement resource, a QCL information field is absent from the CLI resource configuration, and the rule or the configuration configures a flag for the QCL Type-D assumption to follow a first indicated downlink or joint TCI state ID and a second indicated downlink or joint TCI state ID for the CLI measurement.

In a fifty-third aspect, alone or in combination with one or more of the first through fifty-second aspects, process 900 includes transmitting a CLI resource configuration for a UE-to-UE CLI measurement resource, where the UE-to-UE CLI measurement resource is an SP CLI measurement resource, and process 900 includes transmitting a MAC-CE that semi-persistent activates or deactivates the CLI-RSSI resource set or the SRS-RSRP resource set.

In a fifty-fourth aspect, alone or in combination with one or more of the first through fifty-third aspects, the rule or the configuration specifies that an indicated TCI state ID in the MAC-CE is not applied if the TCI state ID is defined in a TCI states to add list or a downlink or joint TCI state list under the unified TCI framework. In some aspects, the TCI state ID is configured per CLI received signal strength indicator resource or resource set or per sounding reference signal reference signal received power measurement resource or resource set.

In a fifty-fifth aspect, alone or in combination with one or more of the first through fifty-fourth aspects, the MAC-CE activates or deactivates SP CSI reporting on a PUCCH. In some aspects, the MAC-CE includes more than 4 fields that activate or deactivate more than 4 CSI or CLI reporting resources or resource sets.

In a fifty-sixth aspect, alone or in combination with one or more of the first through fifty-fifth aspects, the UE-to-UE CLI measurement resource is a semi-persistent CLI measurement resource, and transmitting the CLI report includes transmitting the CLI report via a CSI reporting configuration.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 1-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 1 and FIG. 2. Additionally, or alternatively, one or more components shown in FIG. 10 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the UE described in connection with FIG. 1 and FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive a CLI resource configuration for a UE-to-UE CLI measurement resource. The communication manager 1006 may determine a QCL Type-D assumption per CLI resource based at least in part on a rule or a configuration associated with QCL Type-D assumption determination. The communication manager 1006 may measure UE-to-UE CLI based at least in part on the determined QCL Type-D assumption per CLI resource and the CLI measurement resource. The transmission component 1004 may transmit a CLI report that indicates CLI measurement results associated with the determined QCL Type-D assumption.

The transmission component 1004 may transmit an indication of a UE capability for supporting configuration of the UE with a QCL Type-D assumption for the CLI measurement resource.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network entity, or a network entity may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 1-7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network entity described in connection with FIG. 1 and FIG. 2. Additionally, or alternatively, one or more components shown in FIG. 11 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the network entity described in connection with FIG. 1 and FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the network entity described in connection with FIG. 1 and FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit a rule or a configuration associated with QCL Type-D assumption determination. The reception component 1102 may receive a CLI report that indicates CLI measurements and a determined QCL Type-D assumption.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication performed by a user equipment (UE), comprising: receiving a cross-link interference (CLI) resource configuration for a UE-to-UE CLI measurement resource; determining a quasi-co-location (QCL) Type-D assumption per CLI resource based at least in part on a rule or a configuration associated with QCL Type-D assumption determination; measuring UE-to-UE CLI based at least in part on the determined QCL Type-D assumption per CLI resource and the UE-to-UE CLI measurement resource; and transmitting a CLI report that indicates CLI measurement results associated with the determined QCL Type-D assumption.
Aspect 2: The method of Aspect 1, wherein the CLI measurements are Layer 1-based UE-to-UE CLI measurements.
Aspect 3: The method of any of Aspects 1-2, wherein the UE-to-UE CLI measurement resource includes a CLI received signal strength indicator resource or a sounding reference signal reference signal received power resource.
Aspect 4: The method of any of Aspects 1-3, wherein the rule specifies that if a QCL Type-D assumption is not configured at the UE, the UE determines the QCL Type-D assumption based at least in part on a latest transmission configuration indicator state indicated for a physical downlink shared channel or a control resource set.
Aspect 5: The method of any of Aspects 1-4, wherein the rule specifies that if a QCL Type-D assumption is not configured at the UE, the UE determines the QCL Type-D assumption based at least in part on an indicated transmission configuration indicator (TCI) state indicated for a unified TCI framework.
Aspect 6: The method of any of Aspects 1-5, wherein the rule specifies that if a QCL Type-D assumption is not configured at the UE, and if a latest physical downlink shared channel has two indicated transmission configuration indicator (TCI) states, the UE determines the QCL Type-D assumption based at least in part on a first indicated TCI state or a second indicated TCI state for a multiple transmit receive point unified TCI framework.
Aspect 7: The method of any of Aspects 1-6, wherein the rule specifies that if a QCL Type-D assumption is not configured at the UE, and if a latest physical downlink shared channel has two indicated transmission configuration indicator (TCI) states, the UE determines the QCL Type-D assumption based at least in part on both a first indicated TCI state and a second indicated TCI state for a multiple transmit receive point unified TCI framework.
Aspect 8: The method of any of Aspects 1-7, further comprising transmitting an indication of a UE capability for supporting configuration of the UE with a QCL Type-D assumption for the CLI measurement resource.
Aspect 9: The method of Aspect 8, wherein the UE-to-UE CLI measurement resource is a Layer 1 CLI measurement resource that is used with an indicated transmission configuration indicator (TCI) state per channel or reference signal.
Aspect 10: The method of Aspect 8, wherein the UE-to-UE CLI measurement resource is a Layer 1 CLI measurement resource that is used with a single transmit receive point unified transmission configuration indicator (TCI) state.
Aspect 11: The method of Aspect 8, wherein the UE-to-UE CLI measurement resource is a Layer 1 CLI measurement resource that is used with a multiple transmit receive point unified transmission configuration indicator (TCI) state.
Aspect 12: The method of Aspect 8, wherein the UE-to-UE CLI measurement resource is a Layer 1 CLI measurement resource that is used with a single transmit receive point (TRP) unified transmission configuration indicator (TCI) state and a multiple TRP unified TCI state.
Aspect 13: The method of Aspect 8, wherein the UE-to-UE CLI measurement resource is a Layer 1 CLI measurement resource that is used with an indicated transmission configuration indicator (TCI) state per channel or reference signal or both a single transmit receive point (TRP) unified TCI state and a multiple TRP unified TCI state.
Aspect 14: The method of any of Aspects 1-13, wherein the UE-to-UE CLI measurement resource is an aperiodic (AP) CLI measurement resource triggered by a trigger state.
Aspect 15: The method of Aspect 14, wherein the trigger state indicates a configured TCI state identifier for the QCL Type-D assumption.
Aspect 16: The method of Aspect 14, wherein the trigger state indicates a flag for the QCL Type-D assumption to follow an indicated TCI state identifier for CLI measurement or to not follow the indicated TCI state identifier for CLI measurement.
Aspect 17: The method of Aspect 14, wherein the unified TCI framework is a multiple transmit receive point unified TCI framework, and wherein the trigger state indicates a configured TCI state identifier for the QCL Type-D assumption.
Aspect 18: The method of Aspect 14, wherein the unified TCI framework is a multiple transmit receive point unified TCI framework, and wherein the trigger state indicates a flag for the QCL Type-D assumption to follow a first indicated TCI state identifier for CLI measurement.
Aspect 19: The method of Aspect 14, wherein the unified TCI framework is a multiple transmit receive point unified TCI framework, and wherein the trigger state indicates a flag for the QCL Type-D assumption to follow a second indicated TCI state identifier for CLI measurement.
Aspect 20: The method of Aspect 14, wherein the unified TCI framework is a multiple transmit receive point unified TCI framework, and wherein the trigger state indicates a flag for the QCL Type-D assumption to follow a first indicated TCI state identifier (ID) and a second indicated TCI state ID for CLI measurement.
Aspect 21: The method of Aspect 14, wherein the rule or the configuration specifies that the network entity is to not configure a channel measurement resource (CMR) configuration or the UE is to ignore the CMR configuration.
Aspect 22: The method of Aspect 21, wherein the rule or the configuration specifies that the CMR configuration is optionally configured based at least in part on a CLI received signal strength indicator resource or a sounding reference signal reference signal received power resource indicated in a report quantity parameter.
Aspect 23: The method of Aspect 21, wherein the rule or the configuration specifies that if the CMR configuration is configured, the UE is to ignore the configuration based at least in part on a CLI received signal strength indicator resource or a sounding reference signal reference signal received power resource indicated in a report quantity parameter.
Aspect 24: The method of Aspect 14, wherein the rule or the configuration specifies that the UE is to either: configure a channel measurement resource (CMR) with a CMR configuration or use a QCL information field in the CMR configuration for CLI measurement and ignore other fields of the CMR configuration.
Aspect 25: The method of Aspect 14, wherein the CLI resource configuration configures the UE-to-UE CLI measurement resource via a UE-to-UE CLI measurement resource for interference field.
Aspect 26: The method of Aspect 25, wherein the UE-to-UE CLI measurement resource is a CLI received signal strength indicator (RSSI) resource or a sounding reference signal (SRS) reference signal received power (RSRP) resource.
Aspect 27: The method of Aspect 26, wherein the CLI resource configuration configures the CLI-RSSI resource or the SRS-RSRP resource with a QCL information field.
Aspect 28: The method of Aspect 14, wherein the CLI-RSSI resource or the SRS-RSRP resource is configured under a channel state information interference measurement (CSI-IM) resource information element (IE).
Aspect 29: The method of Aspect 28, wherein the CLI-RSSI resource or the SRS-RSRP resource follows a pattern associated with a CSI-IM resource pattern.
Aspect 30: The method of Aspect 29, wherein the pattern is a CLI-RSSI pattern with contiguous resource blocks, is a specified CSI-IM pattern, is a comb pattern, or follows a channel state information reference signal (CSI-RS) pattern of a CSI-RS pattern table.
Aspect 31: The method of Aspect 29, wherein the pattern is associated with a QCL information field associated with the CSI-IM IE.
Aspect 32: The method of Aspect 31, wherein the QCL information field is dedicated to specifying the UE-to-UE CLI measurement resource.
Aspect 33: The method of Aspect 29, wherein a QCL information field is absent from the CLI resource configuration, and wherein the pattern is associated with a latest physical downlink shared channel beam or a latest control resource set beam of a single transmit receive point framework.
Aspect 34: The method of Aspect 29, wherein the pattern follows QCL information associated with an indicated downlink or joint TCI state.
Aspect 35: The method of Aspect 29, wherein the rule or the configuration indicates a flag per CLI-RSSI resource or SRS-RSRP resource that indicates whether to apply an indicated downlink or joint TCI state.
Aspect 36: The method of Aspect 29, wherein the rule or the configuration indicates a flag per CLI-RSSI resource set or SRS-RSRP resource set that indicates whether to apply an indicated downlink or joint TCI state.
Aspect 37: The method of Aspect 29, wherein the CLI-RSSI resource or the SRS-RSRP resource applies QCL information of a channel measurement resource configuration.
Aspect 38: The method of Aspect 29, wherein the CLI-RSSI resource or the SRS-RSRP resource applies QCL information associated with the CSI-IM resource pattern.
Aspect 39: The method of Aspect 14, wherein the CLI resource configuration follows a rule that the AP CLI measurement resource and an AP CSI resource share a same trigger state identifier (ID) space of the CLI resource configuration.
Aspect 40: The method of Aspect 39, wherein the trigger state ID space includes an additional bit in a channel state information request in downlink control information for the AP CLI measurement resource and the AP CSI resource.
Aspect 41: The method of Aspect 39, further comprising transmitting a capability indication that indicates whether the UE is capable of supporting a trigger state ID space that is greater than 64 trigger states.
Aspect 42: The method of Aspect 14, wherein the CLI resource configuration indicates the AP CLI measurement resource and an AP CSI resource in separate trigger state identifier (ID) spaces of the CLI resource configuration.
Aspect 43: The method of Aspect 14, wherein a CLI report configuration indicates a quantity of reported CLI resources.
Aspect 44: The method of Aspect 14, wherein a rule or a configuration for CLI reporting indicates a specific priority value for CLI reporting.
Aspect 45: The method of any of Aspects 15-44, wherein the UE-to-UE CLI measurement resource is a periodic CLI measurement resource configured with a QCL information field via radio resource control (RRC) signaling.
Aspect 46: The method of any of Aspects 15-45, wherein the UE-to-UE CLI measurement resource is a periodic CLI measurement resource, wherein a QCL information field is absent from the CLI resource configuration, and wherein the QCL Type-D assumption is based at least in part on a latest physical downlink shared channel beam or a latest control resource set beam for a single transmit receive point framework.
Aspect 47: The method of any of Aspects 15-46, wherein the UE-to-UE CLI measurement resource is a periodic CLI measurement resource, wherein a QCL information field is absent from the CLI resource configuration, and wherein the QCL Type-D assumption is based at least in part on QCL information included in an indicated downlink or joint TCI state.
Aspect 48: The method of any of Aspects 15-47, wherein the UE-to-UE CLI measurement resource is a periodic CLI measurement resource, wherein a QCL information field is absent from the CLI resource configuration, and wherein the rule or the configuration configures a flag per UE-to-UE CLI measurement resource that indicates whether to apply an indicated downlink or joint transmission configuration indicator state for the QCL Type-D assumption.
Aspect 49: The method of any of Aspects 15-48, wherein the UE-to-UE CLI measurement resource is a periodic CLI measurement resource, wherein a QCL information field is absent from the CLI resource configuration, and wherein the rule or the configuration configures a flag per UE-to-UE CLI measurement resource set that indicates whether to apply an indicated downlink or joint transmission configuration indicator state for the QCL Type-D assumption.
Aspect 50: The method of any of Aspects 15-49, wherein the UE-to-UE CLI measurement resource is a periodic CLI measurement resource, wherein a QCL information field is absent from the CLI resource configuration, and wherein the rule or the configuration configures a downlink or joint transmission configuration indicator state identifier of a multiple transmit receive point framework for the QCL Type-D assumption.
Aspect 51: The method of any of Aspects 15-50, wherein the UE-to-UE CLI measurement resource is a periodic CLI measurement resource, wherein a QCL information field is absent from the CLI resource configuration, and wherein the rule or the configuration configures a flag for the QCL Type-D assumption to follow a first indicated downlink or joint transmission configuration indicator (TCI) state identifier (ID) for the CLI measurement.
Aspect 52: The method of any of Aspects 15-51, wherein the UE-to-UE CLI measurement resource is a periodic CLI measurement resource, wherein a QCL information field is absent from the CLI resource configuration, and wherein the rule or the configuration configures a flag for the QCL Type-D assumption to follow a second indicated downlink or joint transmission configuration indicator (TCI) state identifier (ID) for the CLI measurement.
Aspect 53: The method of any of Aspects 15-52, wherein the UE-to-UE CLI measurement resource is a periodic CLI measurement resource, wherein a QCL information field is absent from the CLI resource configuration, and wherein the rule or the configuration configures a flag for the QCL Type-D assumption to follow a first indicated downlink or joint transmission configuration indicator (TCI) state identifier (ID) and a second indicated downlink or joint TCI state ID for the CLI measurement.
Aspect 54: The method of any of Aspects 1-3, wherein the UE-to-UE CLI measurement resource is a semi-persistent (SP) CLI measurement resource, and wherein the method includes receiving a medium access control control element (MAC-CE) that semi-persistent activates or deactivates the CLI received signal strength indicator or a sounding reference signal reference signal received power measurement resource or resource set.
Aspect 55: The method of Aspect 54, wherein the rule or the configuration specifies that an indicated transmission configuration indicator (TCI) state identifier (ID) in the MAC-CE is not applied if the TCI state ID is defined in a TCI states to add list or a downlink or joint TCI state list under the unified TCI framework.
Aspect: The method of Aspect 55, wherein the TCI state ID is configured per CLI received signal strength indicator resource or resource set or per sounding reference signal reference signal received power measurement resource or resource set.
Aspect 56: The method of Aspect 54, wherein the MAC-CE activates or deactivates SP CSI reporting on a physical uplink control channel.
Aspect: The method of Aspect 56, wherein the MAC-CE includes more than 4 fields that activate or deactivate more than 4 CSI or CLI reporting resources or resource sets.
Aspect 57: The method of any of Aspects 54-56, wherein the UE-to-UE CLI measurement resource is a semi-persistent CLI measurement resource, and wherein transmitting the CLI report includes transmitting the CLI report via a CSI reporting configuration.
Aspect 58: A method of wireless communication performed by a network entity, comprising: transmitting a rule or a configuration associated with quasi-co-location (QCL) Type-D assumption determination; and receiving a cross-link interference (CLI) report that indicates CLI measurements and a determined QCL Type-D assumption.
Aspect 59: The method of Aspect 58, wherein the CLI measurements are Layer 1-based user equipment (UE)-to-UE CLI measurements.
Aspect 60: The method of any of Aspects 58-59, further comprising transmitting a CLI resource configuration for a user equipment (UE)-to-UE CLI measurement resource, wherein the UE-to-UE CLI measurement resource includes a CLI received signal strength indicator resource or a sounding reference signal reference signal received power resource.
Aspect 61: The method of any of Aspects 58-60, wherein the rule specifies that if a QCL Type-D assumption is not configured at a user equipment (UE), the UE determines the QCL Type-D assumption based at least in part on a latest transmission configuration indicator state indicated for a physical downlink shared channel or a control resource set.
Aspect 62: The method of any of Aspects 58-61, wherein the rule specifies that if a QCL Type-D assumption is not configured at a user equipment (UE), the UE determines the QCL Type-D assumption based at least in part on an indicated transmission configuration indicator (TCI) state indicated for a unified TCI framework.
Aspect 63: The method of any of Aspects 58-62, wherein the rule specifies that if a QCL Type-D assumption is not configured at a user equipment (UE), and if a latest physical downlink shared channel has two indicated transmission configuration indicator (TCI) states, the UE determines the QCL Type-D assumption based at least in part on a first indicated TCI state or a second indicated TCI state for a multiple transmit receive point unified TCI framework.
Aspect 64: The method of any of Aspects 58-63, wherein the rule specifies that if a QCL Type-D assumption is not configured at a user equipment (UE), and if a latest physical downlink shared channel has two indicated transmission configuration indicator (TCI) states, the UE determines the QCL Type-D assumption based at least in part on both a first indicated TCI state and a second indicated TCI state for a multiple transmit receive point unified TCI framework.
Aspect 65: The method of any of Aspects 58-64, further comprising receiving an indication of a user equipment (UE) capability for supporting configuration of the UE with a QCL Type-D assumption for the CLI measurement resource.
Aspect 66: The method of Aspect 65, further comprising transmitting a CLI resource configuration for a user equipment (UE)-to-UE CLI measurement resource, wherein the UE-to-UE CLI measurement resource is a Layer 1 CLI measurement resource that is used with an indicated transmission configuration indicator (TCI) state per channel or reference signal.
Aspect 67: The method of Aspect 65, further comprising transmitting a CLI resource configuration for a user equipment (UE)-to-UE CLI measurement resource, wherein the UE-to-UE CLI measurement resource is a Layer 1 CLI measurement resource that is used with a single transmit receive point unified transmission configuration indicator (TCI) state.
Aspect 68: The method of Aspect 65, further comprising transmitting a CLI resource configuration for a user equipment (UE)-to-UE CLI measurement resource, wherein the UE-to-UE CLI measurement resource is a Layer 1 CLI measurement resource that is used with a multiple transmit receive point unified transmission configuration indicator (TCI) state.
Aspect 69: The method of Aspect 65, further comprising transmitting a CLI resource configuration for a user equipment (UE)-to-UE CLI measurement resource, wherein the UE-to-UE CLI measurement resource is a Layer 1 CLI measurement resource that is used with a single transmit receive point (TRP) unified transmission configuration indicator (TCI) state and a multiple TRP unified TCI state.
Aspect 70: The method of Aspect 65, further comprising transmitting a CLI resource configuration for a user equipment (UE)-to-UE CLI measurement resource, wherein the UE-to-UE CLI measurement resource is a Layer 1 CLI measurement resource that is used with an indicated transmission configuration indicator (TCI) state per channel or reference signal or both a single transmit receive point (TRP) unified TCI state and a multiple TRP unified TCI state.
Aspect 71: The method of Aspect 65, further comprising transmitting a CLI resource configuration for a user equipment (UE)-to-UE CLI measurement resource, wherein the UE-to-UE CLI measurement resource is an aperiodic (AP) CLI measurement resource triggered by a trigger state.
Aspect 72: The method of Aspect 71, wherein the trigger state indicates a configured TCI state identifier for the QCL Type-D assumption.
Aspect 73: The method of Aspect 71, wherein the trigger state indicates a flag for the QCL Type-D assumption to follow an indicated TCI state identifier for CLI measurement or to not follow the indicated TCI state identifier for CLI measurement.
Aspect 74: The method of Aspect 71, wherein the unified TCI framework is a multiple transmit receive point unified TCI framework, and wherein the trigger state indicates a configured TCI state identifier for the QCL Type-D assumption.
Aspect 75: The method of Aspect 71, wherein the unified TCI framework is a multiple transmit receive point unified TCI framework, and wherein the trigger state indicates a flag for the QCL Type-D assumption to follow a first indicated TCI state identifier for CLI measurement.
Aspect 76: The method of Aspect 71, wherein the unified TCI framework is a multiple transmit receive point unified TCI framework, and wherein the trigger state indicates a flag for the QCL Type-D assumption to follow a second indicated TCI state identifier for CLI measurement.
Aspect 77: The method of Aspect 71, wherein the unified TCI framework is a multiple transmit receive point unified TCI framework, and wherein the trigger state indicates a flag for the QCL Type-D assumption to follow a first indicated TCI state identifier (ID) and a second indicated TCI state ID for CLI measurement.
Aspect 78: The method of Aspect 71, wherein the rule or the configuration specifies that the network entity is to not configure a channel measurement resource (CMR) configuration or the UE is to ignore the CMR configuration.
Aspect 79: The method of Aspect 78, wherein the rule or the configuration specifies that the CMR configuration is optionally configured based at least in part on a CLI received signal strength indicator resource or a sounding reference signal reference signal received power resource indicated in a report quantity parameter.
Aspect 80: The method of Aspect 78, wherein the rule or the configuration specifies that if the CMR configuration is configured, the UE is to ignore the configuration based at least in part on a CLI received signal strength indicator resource or a sounding reference signal reference signal received power resource indicated in a report quantity parameter.
Aspect 81: The method of Aspect 71, wherein the rule or the configuration specifies that the UE is to either: configure a channel measurement resource (CMR) with a CMR configuration or use a QCL information field in the CMR configuration for CLI measurement and ignore other fields of the CMR configuration.
Aspect 82: The method of Aspect 71, wherein the CLI resource configuration configures the UE-to-UE CLI measurement resource via a UE-to-UE CLI measurement resource for interference field.
Aspect 83: The method of Aspect 82, wherein the UE-to-UE CLI measurement resource is a CLI received signal strength indicator (RSSI) resource or a sounding reference signal (SRS) reference signal received power (RSRP) resource.
Aspect 84: The method of Aspect 82, wherein the CLI resource configuration configures the CLI-RSSI resource or the SRS-RSRP resource with a QCL information field.
Aspect 85: The method of Aspect 71, wherein the CLI-RSSI resource or the SRS-RSRP resource is configured under a channel state information interference measurement (CSI-IM) resource information element (IE).
Aspect 86: The method of Aspect 85, wherein the CLI-RSSI resource or the SRS-RSRP resource follows a pattern associated with a channel state information interference measurement (CSI-IM) resource pattern.
Aspect 87: The method of Aspect 86, wherein the pattern is a CLI-RSSI pattern with contiguous resource blocks, is a specified CSI-IM pattern, is a comb pattern, or follows a channel state information reference signal (CSI-RS) pattern of a CSI-RS pattern table.
Aspect 88: The method of Aspect 86, wherein the pattern is associated with a QCL information field associated with the CSI-IM IE.
Aspect 89: The method of Aspect 88, wherein the QCL information field is dedicated to specifying the UE-to-UE CLI measurement resource.
Aspect 90: The method of Aspect 86, wherein a QCL information field is absent from the CLI resource configuration, and wherein the pattern is associated with a latest physical downlink shared channel beam or a latest control resource set beam of a single transmit receive point framework.
Aspect 91: The method of Aspect 86, wherein the pattern follows QCL information associated with an indicated downlink or joint TCI state.
Aspect 92: The method of Aspect 86, wherein the rule or the configuration indicates a flag per CLI-RSSI resource or SRS-RSRP resource that indicates whether to apply an indicated downlink or joint TCI state.
Aspect 93: The method of Aspect 86, wherein the rule or the configuration indicates a flag per CLI-RSSI resource set or SRS-RSRP resource set that indicates whether to apply an indicated downlink or joint TCI state.
Aspect 94: The method of Aspect 86, wherein the CLI-RSSI resource or the SRS-RSRP resource applies QCL information of a channel measurement resource configuration.
Aspect 95: The method of Aspect 86, wherein the CLI-RSSI resource or the SRS-RSRP resource applies QCL information associated with the CSI-IM resource pattern.
Aspect 96: The method of Aspect 71, wherein the CLI resource configuration follows a rule that the AP CLI measurement resource and an AP CSI resource share a same trigger state identifier (ID) space of the CLI resource configuration.
Aspect 97: The method of Aspect 96, wherein the trigger state ID space includes an additional bit in a channel state information request in downlink control information for the AP CLI measurement resource and the AP CSI resource.
Aspect 98: The method of Aspect 96, further comprising transmitting a capability indication that indicates whether the UE is capable of supporting a trigger state ID space that is greater than 64 trigger states.
Aspect 99: The method of Aspect 71, wherein the CLI resource configuration indicates the AP CLI measurement resource and an AP CSI resource in separate trigger state identifier (ID) spaces of the CLI resource configuration.
Aspect 100: The method of Aspect 71, wherein a CLI report configuration indicates a quantity of reported CLI resources.
Aspect 101: The method of Aspect 71, wherein a rule or a configuration for CLI reporting indicates a specific priority value for CLI reporting.
Aspect 102: The method of any of Aspects 1-3, further comprising transmitting a CLI resource configuration for a user equipment (UE)-to-UE CLI measurement resource, wherein the UE-to-UE CLI measurement resource is a periodic CLI measurement resource configured with a QCL information field via radio resource control (RRC) signaling.
Aspect 103: The method of Aspect 102, further comprising transmitting a CLI resource configuration for a user equipment (UE)-to-UE CLI measurement resource, wherein the UE-to-UE CLI measurement resource is a periodic CLI measurement resource, wherein a QCL information field is absent from the CLI resource configuration, and wherein the QCL Type-D assumption is based at least in part on a latest physical downlink shared channel beam or a latest control resource set beam for a single transmit receive point framework.
Aspect 104: The method of any of Aspects 102-103, further comprising transmitting a CLI resource configuration for a user equipment (UE)-to-UE CLI measurement resource, wherein the UE-to-UE CLI measurement resource is a periodic CLI measurement resource, wherein a QCL information field is absent from the CLI resource configuration, and wherein the QCL Type-D assumption is based at least in part on QCL information included in an indicated downlink or joint TCI state.
Aspect 105: The method of any of Aspects 102-104, further comprising transmitting a CLI resource configuration for a user equipment (UE)-to-UE CLI measurement resource, wherein the UE-to-UE CLI measurement resource is a periodic CLI measurement resource, wherein a QCL information field is absent from the CLI resource configuration, and wherein the rule or the configuration configures a flag per UE-to-UE CLI measurement resource that indicates whether to apply an indicated downlink or joint transmission configuration indicator state for the QCL Type-D assumption.
Aspect 106: The method of any of Aspects 102-105, further comprising transmitting a CLI resource configuration for a user equipment (UE)-to-UE CLI measurement resource, wherein the UE-to-UE CLI measurement resource is a periodic CLI measurement resource, wherein a QCL information field is absent from the CLI resource configuration, and wherein the rule or the configuration configures a flag per UE-to-UE CLI measurement resource set that indicates whether to apply an indicated downlink or joint transmission configuration indicator state for the QCL Type-D assumption.
Aspect 107: The method of any of Aspects 102-106, further comprising transmitting a CLI resource configuration for a user equipment (UE)-to-UE CLI measurement resource, wherein the UE-to-UE CLI measurement resource is a periodic CLI measurement resource, wherein a QCL information field is absent from the CLI resource configuration, and wherein the rule or the configuration configures a downlink or joint transmission configuration indicator state identifier of a multiple transmit receive point framework for the QCL Type-D assumption.
Aspect 108: The method of any of Aspects 102-107, further comprising transmitting a CLI resource configuration for a user equipment (UE)-to-UE CLI measurement resource, wherein the UE-to-UE CLI measurement resource is a periodic CLI measurement resource, wherein a QCL information field is absent from the CLI resource configuration, and wherein the rule or the configuration configures a flag for the QCL Type-D assumption to follow a first indicated downlink or joint transmission configuration indicator (TCI) state identifier (ID) for the CLI measurement.
Aspect 109: The method of any of Aspects 102-108, further comprising transmitting a CLI resource configuration for a user equipment (UE)-to-UE CLI measurement resource, wherein the UE-to-UE CLI measurement resource is a periodic CLI measurement resource, wherein a QCL information field is absent from the CLI resource configuration, and wherein the rule or the configuration configures a flag for the QCL Type-D assumption to follow a second indicated downlink or joint transmission configuration indicator (TCI) state identifier (ID) for the CLI measurement.
Aspect 110: The method of any of Aspects 102-109, further comprising transmitting a CLI resource configuration for a user equipment (UE)-to-UE CLI measurement resource, wherein the UE-to-UE CLI measurement resource is a periodic CLI measurement resource, wherein a QCL information field is absent from the CLI resource configuration, and wherein the rule or the configuration configures a flag for the QCL Type-D assumption to follow a first indicated downlink or joint transmission configuration indicator (TCI) state identifier (ID) and a second indicated downlink or joint TCI state ID for the CLI measurement.
Aspect 111: The method of any of Aspects 1-3, further comprising transmitting a CLI resource configuration for a user equipment (UE)-to-UE CLI measurement resource, wherein the UE-to-UE CLI measurement resource is a semi-persistent (SP) CLI measurement resource, and wherein the method includes transmitting a medium access control control element (MAC-CE) that semi-persistent activates or deactivates the CLI received signal strength indicator or a sounding reference signal reference signal received power measurement resource or resource set.
Aspect: The method of Aspect 111, wherein the TCI state ID is configured per CLI received signal strength indicator resource or resource set or per sounding reference signal reference signal received power measurement resource or resource set.
Aspect 112: The method of Aspect 111, wherein the rule or the configuration specifies that an indicated transmission configuration indicator (TCI) state identifier (ID) in the MAC-CE is not applied if the TCI state ID is defined in a TCI states to add list or a downlink or joint TCI state list under the unified TCI framework.
Aspect 113: The method of Aspect 111, wherein the MAC-CE activates or deactivates SP CSI reporting on a physical uplink control channel.
Aspect: The method of Aspect 113, wherein the MAC-CE includes more than 4 fields that activate or deactivate more than 4 CSI or CLI reporting resources or resource sets.
Aspect 114: The method of any of Aspects 111-113, wherein the UE-to-UE CLI measurement resource is a semi-persistent CLI measurement resource, and wherein transmitting the CLI report includes transmitting the CLI report via a CSI reporting configuration.
Aspect 115: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-114.
Aspect 116: An apparatus for wireless communication at a device, the apparatus comprising one or more memories and one or more processors coupled to the one or more memories, the one or more processors configured to cause the device to perform the method of one or more of Aspects 1-114.
Aspect 117: An apparatus for wireless communication, the apparatus comprising at least one means for performing the method of one or more of Aspects 1-114.
Aspect 118: A non-transitory computer-readable medium storing code for wireless communication, the code comprising instructions executable by one or more processors to perform the method of one or more of Aspects 1-114.
Aspect 119: A non-transitory computer-readable medium storing a set of instructions for wireless communication, the set of instructions comprising one or more instructions that, when executed by one or more processors of a device, cause the device to perform the method of one or more of Aspects 1-114.
Aspect 120: A device for wireless communication, the device comprising a processing system that includes one or more processors and one or more memories coupled with the one or more processors, the processing system configured to cause the device to perform the method of one or more of Aspects 1-114.
Aspect 121: An apparatus for wireless communication at a device, the apparatus comprising one or more memories and one or more processors coupled to the one or more memories, the one or more processors individually or collectively configured to cause the device to perform the method of one or more of Aspects 1-114.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, individually or collectively configured to cause the UE to:
receive a cross-link interference (CLI) resource configuration for a UE-to-UE CLI measurement resource;
determine a quasi-co-location (QCL) Type-D assumption per CLI resource based at least in part on a rule or a configuration associated with QCL Type-D assumption determination;
measure UE-to-UE CLI based at least in part on the determined QCL Type-D assumption per CLI resource and the UE-to-UE CLI measurement resource; and
transmit a CLI report that indicates CLI measurement results associated with the determined QCL Type-D assumption.

2. The apparatus of claim 1, wherein the CLI measurements are Layer 1-based UE-to-UE CLI measurements.

3. The apparatus of claim 1, wherein the UE-to-UE CLI measurement resource includes a CLI received signal strength indicator resource or a sounding reference signal reference signal received power resource.

4. The apparatus of claim 1, wherein the rule specifies that if a QCL Type-D assumption is not configured at the UE, the UE determines the QCL Type-D assumption based at least in part on a latest transmission configuration indicator state indicated for a physical downlink shared channel or a control resource set.

5. The apparatus of claim 1, wherein the rule specifies that if a QCL Type-D assumption is not configured at the UE, the UE determines the QCL Type-D assumption based at least in part on an indicated transmission configuration indicator (TCI) state indicated for a unified TCI framework.

6. The apparatus of claim 1, wherein the rule specifies that if a QCL Type-D assumption is not configured at the UE, and if a latest physical downlink shared channel has two indicated transmission configuration indicator (TCI) states, the UE determines the QCL Type-D assumption based at least in part on a first indicated TCI state, a second indicated TCI state for a multiple transmit receive point unified TCI framework, or both the first indicated TCI state and the second indicated TCI state.

7. The apparatus of claim 1, wherein the one or more processors are individually or collectively configured to cause the UE to transmit an indication of a UE capability for supporting configuration of the UE with a QCL Type-D assumption for the CLI measurement resource.

8. The apparatus of claim 7, wherein the UE-to-UE CLI measurement resource is a Layer 1 CLI measurement resource that is used with:
an indicated transmission configuration indicator (TCI) state per channel or reference signal,
a single transmit receive point (sTRP) unified transmission configuration indicator (TCI) state,
a multiple transmit receive point (mTRP) unified TCI state, or
both the sTRP unified TCI state and the mTRP unified TCI state.

9. The apparatus of claim 1, wherein the UE-to-UE CLI measurement resource is an aperiodic (AP) CLI measurement resource triggered by a trigger state.

10. The apparatus of claim 9, wherein the trigger state indicates a configured TCI state identifier for the QCL Type-D assumption.

11. The apparatus of claim 9, wherein the trigger state indicates a flag for the QCL Type-D assumption to follow an indicated TCI state identifier for CLI measurement or to not follow the indicated TCI state identifier for CLI measurement.

12. The apparatus of claim 9, wherein the trigger state indicates a configured TCI state identifier for the QCL Type-D assumption.

13. The apparatus of claim 9, wherein the trigger state indicates a flag for the QCL Type-D assumption to follow a first indicated TCI state identifier (ID) for CLI measurement, a second indicated TCI state ID for CLI measurement, or both the first indicated TCI state ID and the second indicated TCI state ID.

14. The apparatus of claim 9, wherein the rule or the configuration specifies that a network entity is to not configure a channel measurement resource (CMR) configuration or the UE is to ignore the CMR configuration.

15. The apparatus of claim 14, wherein the rule or the configuration specifies that the CMR configuration is optionally configured based at least in part on a CLI received signal strength indicator resource or a sounding reference signal reference signal received power resource indicated in a report quantity parameter.

16. The apparatus of claim 14, wherein the one or more processors are individually or collectively configured to cause the UE to ignore the configuration based at least in part on a CLI received signal strength indicator resource or a sounding reference signal reference signal received power resource indicated in a report quantity parameter.

17. The apparatus of claim 9, wherein the one or more processors are individually or collectively configured to cause the UE to either:
configure a channel measurement resource (CMR) with a CMR configuration or
use a QCL information field in the CMR configuration for CLI measurement and ignore other fields of the CMR configuration.

18. The apparatus of claim 9, wherein the CLI resource configuration configures the UE-to-UE CLI measurement resource via a UE-to-UE CLI measurement resource for interference field.

19. The apparatus of claim 18, wherein the UE-to-UE CLI measurement resource is a CLI received signal strength indicator (RSSI) resource or a sounding reference signal (SRS) reference signal received power (RSRP) resource.

20. The apparatus of claim 19, wherein the CLI resource configuration configures the CLI-RSSI resource or the SRS-RSRP resource with a QCL information field.

21. The apparatus of claim 19, wherein the CLI-RSSI resource or the SRS-RSRP resource is configured under a channel state information interference measurement (CSI-IM) resource information element (IE).

22. The apparatus of claim 21, wherein the CLI-RSSI resource or the SRS-RSRP resource follows a pattern associated with a CSI-IM resource pattern.

23. The apparatus of claim 22, wherein the pattern is a CLI-RSSI pattern with contiguous resource blocks, is a specified CSI-IM pattern, is a comb pattern, or follows a channel state information reference signal (CSI-RS) pattern of a CSI-RS pattern table.

24. The apparatus of claim 22, wherein the pattern is associated with a QCL information field associated with the CSI-IM IE.

25. The apparatus of claim 24, wherein the QCL information field is dedicated to specifying the UE-to-UE CLI measurement resource.

26. The apparatus of claim 22, wherein a QCL information field is absent from the CLI resource configuration, and wherein the pattern is associated with a latest physical downlink shared channel beam or a latest control resource set beam of a single transmit receive point framework.

27. The apparatus of claim 22, wherein the pattern follows QCL information associated with an indicated downlink or joint TCI state.

28. The apparatus of claim 22, wherein the rule or the configuration indicates a flag per CLI-RSSI resource or SRS-RSRP resource that indicates whether to apply an indicated downlink or joint TCI state.

29. The apparatus of claim 22, wherein the rule or the configuration indicates a flag per CLI-RSSI resource set or SRS-RSRP resource set that indicates whether to apply an indicated downlink or joint TCI state.

30. The apparatus of claim 22, wherein the CLI-RSSI resource or the SRS-RSRP resource applies QCL information of a channel measurement resource configuration.

31. The apparatus of claim 22, wherein the CLI-RSSI resource or the SRS-RSRP resource applies QCL information associated with the CSI-IM resource pattern.

32. The apparatus of claim 9, wherein the CLI resource configuration follows a rule that the AP CLI measurement resource and an AP CSI resource share a same trigger state identifier (ID) space of the CLI resource configuration.

33. The apparatus of claim 32, wherein the trigger state ID space includes an additional bit in a channel state information request in downlink control information for the AP CLI measurement resource and the AP CSI resource.

34. The apparatus of claim 32, wherein the one or more processors are individually or collectively configured to cause the UE to transmit a capability indication that indicates whether the UE is capable of supporting a trigger state ID space that is greater than 64 trigger states.

35. The apparatus of claim 9, wherein the CLI resource configuration indicates the AP CLI measurement resource and an AP CSI resource in separate trigger state identifier (ID) spaces of the CLI resource configuration.

36. The apparatus of claim 9, wherein a CLI report configuration indicates a quantity of reported CLI resources.

37. The apparatus of claim 9, wherein a rule or a configuration for CLI reporting indicates a specific priority value for CLI reporting.

38. The apparatus of claim 1, wherein the UE-to-UE CLI measurement resource is a periodic CLI measurement resource configured with a QCL information field via radio resource control (RRC) signaling.

39. The apparatus of claim 1, wherein the UE-to-UE CLI measurement resource is a periodic CLI measurement resource, wherein a QCL information field is absent from the CLI resource configuration, and wherein the QCL Type-D assumption is based at least in part on a latest physical downlink shared channel beam, a latest control resource set beam for a single transmit receive point framework, or QCL information included in an indicated downlink or joint TCI state.

40. The apparatus of claim 1, wherein the UE-to-UE CLI measurement resource is a periodic CLI measurement resource, wherein a QCL information field is absent from the CLI resource configuration, and wherein the rule or the configuration configures one or more of:
a flag per UE-to-UE CLI measurement resource or resource set that indicates whether to apply an indicated downlink or joint transmission configuration indicator (TCI) state for the QCL Type-D assumption,
a downlink or joint TCI state identifier (ID) of a multiple transmit receive point framework for the QCL Type-D assumption, or
a flag for the QCL Type-D assumption to follow a first indicated downlink or joint TCI state ID for the CLI measurement, a second indicated downlink or joint TCI state ID for the CLI measurement, or both the first indicated downlink or joint TCI state ID and the second indicated downlink or joint TCI state ID.

41. The apparatus of claim 1, wherein the UE-to-UE CLI measurement resource is a semi-persistent (SP) CLI measurement resource, and wherein the one or more processors are individually or collectively configured to cause the UE to includes receiving a medium access control control element (MAC-CE) that semi-persistent activates or deactivates a CLI received signal strength indicator resource or resource set or a sounding reference signal reference signal received power measurement resource or resource set.

42. The apparatus of claim 41, wherein the rule or the configuration specifies that an indicated transmission configuration indicator (TCI) state identifier (ID) in the MAC-CE is not applied if the TCI state ID is defined in a TCI states to add list or a downlink or joint TCI state list under a unified TCI framework, and wherein the TCI state ID is configured per CLI received signal strength indicator resource or resource set or per sounding reference signal reference signal received power measurement resource or resource set.

43. The apparatus of claim 41, wherein the MAC-CE activates or deactivates SP CSI reporting on a physical uplink control channel, and wherein the MAC-CE includes more than 4 fields that activate or deactivate more than 4 CSI or CLI reporting resources or resource sets.

44. The apparatus of claim 1, wherein the UE-to-UE CLI measurement resource is a semi-persistent CLI measurement resource, and wherein transmitting the CLI report includes transmitting the CLI report via a CSI reporting configuration.

45. An apparatus for wireless communication at a network entity, comprising:
one or more memories; and
one or more processors, coupled to the one or more memories, individually or collectively configured to cause the network entity to:
transmit a rule or a configuration associated with quasi-co-location (QCL) Type-D assumption determination; and
receive a cross-link interference (CLI) report that indicates CLI measurements and a determined QCL Type-D assumption.
